(19) United States
(12) Patent Application Publication
(10) Pub. No.: US 2018/0122012 A1
(43) Pub. Date: May 3, 2018

(54) METHODS AND APPARATUSES FOR ATTRIBUTION WITH CUSTOM FACTOR MIMICKING PORTFOLIOS

(71) Applicant: Axioma, Inc., New York, NY (US)

(72) Inventors: Dieter Vandenbussche, Marietta, GA (US); Robert A. Stubbs, Roswell, GA (US)

(21) Appl. No.: 15/475,523

(22) Filed: Mar. 31, 2017

Related U.S. Application Data
(60) Provisional application No. 62/414,106, filed on Oct. 28, 2016.

(51) Int. Cl. G06Q 40/06

(52) U.S. Cl. CPC G06Q 40/06

(57) ABSTRACT

A machine for displaying factor-based performance attribution (PA) results for a set of historical portfolios using a framework that computes the attribution using a set of factor mimicking portfolios (FMPs). By considering different constraints, universes, and rebalance frequencies for the FMPs, different PA results may be obtained. The quality of each PA may be evaluated to identify advantageous PAs for portfolio managers to use. The machine enables portfolio managers to obtain actionable information concerning the sources of investment returns.

The present application claims the benefit of U.S. Provisional Application Ser. No. 62/414,106 filed Oct. 28, 2016, the disclosure of which is incorporated herein by reference in its entirety.

### RELATED APPLICATIONS

The present invention may advantageously be used in conjunction with one or more of the following applications and patents: U.S. patent application Ser. No. 11/668,294 filed Jan. 29, 2007 which issued as U.S. Pat. No. 7,698,202; U.S. patent application Ser. No. 12/958,778 filed Dec. 2, 2010 which issued as U.S. Pat. No. 8,533,089; U.S. patent application Ser. No. 12/711,554 filed Feb. 24, 2010 which issued as U.S. Pat. No. 8,315,936; U.S. patent application Ser. No. 12/827,358 filed Jun. 30, 2010 which was published as U.S. Publication No. 2011/0289017; U.S. patent application Ser. No. 13/503,696 filed Apr. 24, 2012 which issued as U.S. Pat. No. 8,533,107; U.S. patent application Ser. No. 13/503,698 filed Apr. 24, 2012 which issued as U.S. Pat. No. 8,700,516; U.S. patent application Ser. No. 13/892,644 filed May 13, 2013 which was published as U.S. Publication No. 2013/0304671; U.S. patent application Ser. No. 14/025,127 filed Sep. 12, 2013 which was published as U.S. Publication No. 2014/0081889; U.S. patent application Ser. No. 14/051,711 filed Oct. 11, 2013 which was published as U.S. Publication No. 2014/0108295; U.S. patent application Ser. No. 13/654,797 filed Oct. 18, 2012 which was published as U.S. Publication No. 2013/0041848; U.S. patent application Ser. No. 13/965,621 filed Aug. 13, 2013 which was published as U.S. Publication No. 2013/0332391; U.S. patent application Ser. No. 14/336,123 filed Jul. 21, 2014 which was published as U.S. Publication No. 2015/0081592; U.S. patent application Ser. No. 14/203,807 filed Mar. 11, 2014 which was published as U.S. Publication No. 2014/0201107; U.S. patent application Ser. No. 14/482,685 filed Sep. 10, 2014 which was published as U.S. Publication No. 2016/0071213; U.S. patent application Ser. No. 14/495,470 filed Sep. 24, 2014 which was published as U.S. Publication No. 2016/0086278; U.S. patent application Ser. No. 14/505,258 filed Oct. 2, 2014 which was published as U.S. Publication No. 2016/0098796; U.S. patent application Ser. No. 14/519,991 filed Oct. 21, 2014 which was published as U.S. Publication No. 2016/0110811; and U.S. patent application Ser. No. 15/280,144 filed Sep. 29, 2016, all of which are assigned to the assignee of the present application and incorporated by reference herein in their respective entireties.

### FIELD OF INVENTION

The present invention relates generally to methods and apparatuses for producing performance attribution for investment portfolios. In particular, the invention concerns a machine for displaying factor-based performance attribution (PA) results for a set of historical investment portfolios using a framework that computes the attribution using a set of factor mimicking portfolios (FMPs). By considering different constraints, universes, and rebalance frequencies for the FMPs, different PA results may be advantageously obtained. One aspect of the machine of the present invention enables portfolio managers to obtain actionable information concerning the sources of his or her investment returns. Another aspect of the machine of the present invention enables the identification of advantageous FMPs for automating PA. Another aspect of the machine of the present invention associates advantageous FMPs to different portfolio managers in order to characterize each manager's investment performance and investment style in terms of FMP characteristics.

Factor-based performance attribution results are often misleading due to correlation between the factor and specific contributions. Ideally, the correlation between the factor and specific correlations should be low. The present invention provides an improved FMP framework to perform PA in which the correlation of factor and specific contributions is reduced in magnitude.

An improved graphical user interface permits a portfolio manager or a manager of portfolio managers to readily create, display and select a preferred PA using FMPs that provides the most intuitive and actionable information concerning the sources of the portfolio's return.

### BACKGROUND OF THE INVENTION

Factor-based performance attribution (PA) has been used in the investment management community for decades to demonstrate the added value of active portfolio management. The methodology typically relies on factor and specific return models to decompose and explain the return of the portfolio in terms of distinct contributions. Often, the factor and specific return models are associated with a factor risk model. The portion of the portfolio return that can be explained by the factors is called the factor contribution. The remainder of the return is called the asset-specific contribution, the specific contribution, or the residual contribution.

By decomposing the historical returns of a portfolio into intuitive factors, one seeks to identify the particular bets or biases in a portfolio that helped or hurt overall performance.

If a fundamental or quantitative portfolio manager constructs a portfolio based on a criterion that is not well explained by the factors employed, then factor-based performance attribution may attribute a significant portion of the return to the specific or residual contribution.

FIG. 1 shows a summary PA report 10 associated with a traditional factor-based PA. The report decomposes the return of a portfolio with respect to a benchmark into a specific contribution 11, which is 2.47% and a net factor contribution 12, which is 1.35%. The summary includes other decompositions. The net factor contribution is further decomposed into style, industry, and market contributions; best and worst factor contributions are listed and shown graphically, etc. In addition, parameters such as the benchmark, risk model, time period, and PA attribution frequency are summarized at the top of the report.

FIG. 2 shows a graphical representation 24 of a traditional PA result for a value factor. A time series of active value exposures is shown by bars 25, while the cumulative active value contribution is shown by line 27 in graphical representation 26.

Recent trends in investment management have only increased the importance of factor-based PA. The advent of low cost, “smart” beta exchange traded funds (ETFs) and other factor products allow institutional and individual investors to obtain and maintain desired exposure(s) in their portfolios to intuitive factors simply by buying the appropriate ETF or combination of ETFs. As a result, active portfolio managers have been forced to demonstrate strong evidence that the source of their performance cannot be replicated simply by buying a set of low cost ETFs. Investors are demanding such evidence and scrutinizing it in detail before making their investment decisions. Asset managers have a variety of tools at their disposal, and factor based PA is a key component for making that case.

In traditional factor based PA, one seeks to explain the active return of a portfolio through the lens of a collection of factors that make up a returns model. Specifically, the returns model takes the form

r=Xf+ε, (1)

where r represents the excess returns of the assets, f represents the returns of the factors in the model, X represents the exposures (also called sensitivities) of assets to these factors, and ε is the residual or specific return of the assets; in other words, ε is the return that cannot be explained by the asset's exposures to the factors.

When the returns model, (1), is formulated, one of the central guiding principles is the idea that the specific return ε should be at least approximately uncorrelated with each component of the factor return vector. When the factor returns are estimated by a cross-sectional regression with appropriate weights, the properties of linear regression ensure that ε is exactly uncorrelated with the factor returns at the point in time at which the model is estimated.

Given a portfolio represented by investment weights, w, the portfolio's return can be decomposed into a factor contribution and a specific contribution as follows:

w^{T}r=w^{T}Xf+w^{T}ε (2)

The first term on the right-hand side of equation (2), w^{T}Xf, is the factor contribution. The second term on the right-hand side of equation (2), w^{T}ε, is the specific or residual contribution. Note that the factor contribution can be further decomposed into contribution attributable to individual factors or groups of factors. Another way to interpret the factor contribution, w^{T}Xf, is that that each element of the factor return vector f represents the return for a portfolio with a unit of exposure to that factor.

In general, active portfolio managers split into two groups depending on which contribution—factor or specific—is expected to dominate equation (2). Active portfolio managers who develop investment signals based on well-known factors such as value, growth, or momentum would expect most of their performance to be explained by those factors. As a result, for these portfolios mangers, the factor contribution of PA would likely be larger (positive or negative) than the specific contribution. Alternatively, portfolio managers whose expertise is picking individual stocks but have no views on factors would expect the specific contribution to dominate the PA results. By monitoring the relative contributions of the factor and specific components, portfolio managers can quantitatively demonstrate the value of their investment processes. They can also incrementally improve it by making appropriate adjustments.

However, factor-based PA is difficult to interpret when both contributions—factor and specific—are substantial, and especially hard to interpret if they are both substantial but of opposite signs. When this latter circumstance occurs, it is difficult to develop effective strategies for improving the investment process since changes to improve, say, the factor exposures and thereby modify the factor contribution are likely to adversely affect the specific return. It is also hard to demonstrate to a potential investor that a particular investment decision has improved the investment performance. Unfortunately, such results—substantial factor and specific contributions of opposite sign—are commonly encountered using traditional factor-based PA.

Factor-based PA based on models like equation (1) are easy to compute and readily available in many analytic systems. However, one drawback of these systems is that they rely on off-the-shelf, standard return model estimates provided by commercial vendors such as Axioma Inc. (Axioma). These standard return models may not always capture all the factors a portfolio manager uses in his or her investment process. Important but missing factors would likely cause the specific component of PA to be larger than desired. In addition, the universe of investments in the standard models may not be the same as the universe employed by the portfolio manager, and the frequency at which returns are estimated may be different. Also, the portfolio manager may be under several mandated investment constraints (such as being long-only or having a limited amount of turnover) that are not well captured by the standard linear return model.

One solution to these problems has been the introduction of systems that allow portfolio managers to construct customized linear return models and factor risk models. These tools ensure that all the relevant factors are in the linear return model, that the estimation universe matches the universe of the portfolio manager, and that the rebalance frequencies are commensurate. Although custom risk models can significantly improve factor-based PA, they do not always lead to intuitive results. One disadvantage of using a custom risk model is that it requires constructing a complete factor risk model. Such construction can be a labor-intensive and costly process. Furthermore, even with custom risk models, PA results may still prove difficult to interpret.

The present invention takes advantage of three separate but interconnected areas of investment portfolio management: (a) factor risk models; (b) quantitative methods for portfolio construction (e.g., optimization); and (c) performance attribution. Illustrative prior art of each of these areas is addressed briefly below.

First, the prior art concerning factor risk models is addressed. In the present invention, commercial and custom factor risk models may be employed to calculate traditional factor-based PA. They may also serve as a source for a family of relevant factors over which to compute an FMP. They may also be used to estimate the risk or active risk of an investment portfolio.

For over three decades, commercial risk model vendors have sold factor risk models to estimate the risk of a portfolio where risk is the standard deviation of the portfolio returns. Alternatively, these same models may be used to estimate the variance of a portfolio, since variance is the square of the standard deviation. Factor risk models provide an estimate of the asset-asset covariance matrix, Q, which estimates the future covariance of each pair of asset returns using historical return data.

To obtain reliable variance or covariance estimates based on historical return data, the number of historical time periods used for estimation should be of the same order of magnitude as the number of assets, N. Often, there may be insufficient historical time periods. For example, new companies and bankrupt companies have abbreviated historical price data and companies that undergo mergers or acquisitions have non-unique historical price data. As a result, the covariances estimated from historical data can lead to matrices that are numerically ill-conditioned. Such covariance estimates are of limited value.

Factor risk models were developed, in part, to overcome these short comings. Factor risk models represent the expected variances and covariances of security returns using a set of M factors, where M is much smaller than N, that are derived using statistical, fundamental, or macro-economic information or a combination of any of such types of information. For each factor, every asset covered by the factor risk model is given a score. The N by M matrix of factors scores is called the factor exposures or factor loadings. In addition, a factor return is estimated for each factor at each time that the model is re-estimated. Given exposures of the securities to the factors and the covariances of factor returns, the covariances of security returns can be expressed as a function of the factor exposures, the covariances of factor returns, and a remainder, called the specific risk of each security. Factor risk models typically have between 20 and 200 factors. Even with, say, 80 factors and 1000 securities, the total number of values that must be estimated is just over 85,000, as opposed to over 500,000.

A substantial advantage of factor risk models is that since, by construction, M is much smaller than N, factor risk models do not need as many historical time periods to estimate the covariances of factor returns and thus are less susceptible to the ill-conditioning problems that arise when estimating the elements of Q individually.

The commercial importance and expertise required to build high quality factor risk models, as well as, high quality portfolios and trade lists has led to many patented innovations related to factor risk models. These include U.S. Pat. Nos. 7,698,202, 8,315,936, 8,533,089, 8,533,107, and 8,700,516, all of which are assigned to the assignee of the present invention and are incorporated by reference herein in their entirety.

A classic factor mimicking portfolio can be constructed from a matrix of factor exposures taken from a factor risk model. See for example, R. Litterman, Modern Investment Management: An Equilibrium Approach, John Wiley and Sons, Inc., Hoboken, N.J., 2003 (Litterman), which gives detailed descriptions of factor mimicking portfolios and which is incorporated by reference herein in its entirety. Factor mimicking portfolios are designed so that they have exposure to one and only one factor. The exposure to all other factors in the risk model or matrix of factor exposures is zero by construction.

Although traditional FMPs based on the exposure matrix of a factor risk model have been studied for many years, these traditional FMPs suffer disadvantages. For example, most FMPs invest in far too many names—typically, as many names as are available in the universe considered. Hence, for a broad equity benchmark like the Russell 3000 index, each FMP would hold 3000 names. Portfolios with so many names are generally considered uninvestable, as most portfolios limit the number of names held to less than, say, 400 names. Furthermore, many of the positions are short positions, regardless of whether or not the equity is available to short. In general, the fact that most traditional FMPs are uninvestable portfolios in practice is a major drawback. It would be advantageous to create alternative FMPs with investable characteristics.

Next, the prior art for quantitative methods for portfolio construction is addressed, concentrating on optimization approaches for portfolio construction. These approaches are used in the present invention to construct novel FMPs as addressed further herein.

Prior methods for constructing a portfolio of investments with advantageous risk and return characteristics are known. See, for example, Markowitz, in Portfolio Selection: Efficient Diversification of Instruments, Wiley, 1959 (Markowitz) which is incorporated by reference herein in its entirety, developed mean variance optimization (MVO), which is a portfolio construction approach and methodology that is widely used in equity portfolio management.

In MVO, a portfolio is constructed that minimizes the risk of the portfolio while achieving a minimum acceptable level of return. Alternatively, the level of return is maximized subject to a maximum allowable portfolio risk. In traditional mean variance portfolio construction, risk is measured using the standard deviation or variance of possible returns. The family of portfolio solutions solving these optimization problems for different values of either minimum acceptable return or maximum allowable risk is said to form an efficient frontier, which is often depicted graphically on a plot of risk versus return.

There are numerous, well known, variations of MVO that are used for portfolio construction. These variations include methods based on utility functions and the Sharpe ratio.

Portfolio construction procedures often make use of different estimates of portfolio risk, and some make use of an estimate of portfolio return. A crucial issue for these optimization procedures is how sensitive the constructed portfolios are to changes in the estimates of risk and return. Small changes in the estimates of risk and return occur when these quantities are re-estimated at different time periods. They also occur when the raw data underlying the estimates is corrected or when the estimation method itself is modified. Traditional MVO portfolios are known to be sensitive to small changes in the estimated asset return, variances, and covariances. See, for example, J. D. Jobson, and B. Korkei, “Putting Markowitz Theory to Work”, Journal of Portfolio Management, Vol. 7, pp. 70-74, 1981 and R. O. Michaud, “The Markowitz Optimization Enigma: Is Optimized Optimal?”, Financial Analyst Journal, 1989, Vol. 45, pp. 31-42, 1989 and Efficient Asset Management: A Practical Guide to Stock Portfolio Optimization and Asset Allocation, Harvard Business School Press, 1998, (the two Michaud publications are hence referred to collectively as “Michaud”); all of the above cited publications are incorporated by reference herein in their entirety.

Over the many years that MVO and its variants have been commercially employed, a number of practices for constructing portfolios and trade lists using optimization have become standard. As one example, Axioma sells software for constructing portfolios and trade lists that allows portfolio managers to construct portfolios and trade lists that specify general rules and requirements for both the portfolio and the trades. The portfolio can be long only, or it may be long-short. For long-short portfolios, the ratio or leverage between the market value of the short side can be controlled independently or as a function of the market value of the long side. The local universe comprising potential investment assets that may be used to construct the portfolio or trade list can be specified. General grandfathering options are commonly employed to allow the portfolio to hold or keep existing asset investments if they are not in the local universe or do not satisfy constraints that are violated by the initial holdings. In addition, the trade list may or may not allow cross-over (long positions becoming short positions or vice versa), and may or may not use round lotting to restrict the trade or holding sizes to multiples of a fixed numbers of shares. The strategy may also include compliance rules that are specified for subsets of portfolios.

The objective function, which may be minimized or maximized to obtain the optimal portfolio, may include linear terms such as the expected return or alpha. In MVO, the letter M refers to the mean and is the linear tilt of the expected return, sometimes called alpha, which is maximized for the optimal portfolio. The objective function may include tilts or linear terms for the long and short holdings separately. The objective function may include risk terms, which refer to the standard deviation of possible returns, or variance terms, which refer to the square of the standard deviations of possible returns. These risk terms may be computed using the total holdings, or they may be computed using only the active holdings relative to a benchmark of investment holdings. In this case, the risk and variance terms are termed active risk or active variance. In MVO, the letter V refers to variance, either total or active, and is minimized. In many, if not most, cases, a commercial factor risk model is used to estimate the risk or variance of the portfolio. The objective function terms may also include the costs of trading the portfolio. Such costs may include both the costs charged directly as well as indirect market impact costs, such as changes in market prices caused by the trade itself. The objective function may also include terms designed to benefit the portfolio when taxes are considered. Taxable losses may be maximized while taxable gains—both short and long term and for various rates—may be minimized. In modern portfolio and trade list construction software, there is great flexibility to consider different, weighted combinations of these terms in the objective function to compute a desired, optimal portfolio.

The portfolio construction strategy will usually include a set of constraints that must be satisfied by the optimal portfolio or trade list. These constraints may include maximum and/or minimum bounds on the holdings or exposures of the holdings. For instance, the maximum and minimum asset weights in the portfolio may be specified. Or the maximum or minimum net exposure of assets to an industry, sector, or country may be specified. The maximum and minimum net exposure of the portfolio or subsets of the portfolio to general attributes such as market capitalization or average daily traded volume may also be specified as constraints on the portfolio or trade list. Instead of including risk or variance in the objective function, the maximum allowable risk, active risk, variance, or active variance may be specified as a constraint. In addition, the marginal contribution to risk or active risk, which is the derivative of the risk with respect to an asset's weight in the portfolio, may also be given a maximum value. The constraints may impose limits on the kinds and size of trades employed. That is, some assets may not be allowed to trade, while other asset positions may be entirely liquidated. The total transaction cost of trades may be constrained to be less than a maximum allowable amount. The total number of names held or traded may also be constrained. The taxable gains and liabilities for the investment holdings may be constrained.

Of course, with more sophisticated software, the number and variety of possible objective terms and constraints increases.

Third, the prior art concerning factor-based PA is addressed. Litterman provides an entire chapter (Chapter 19) to performance attribution, and summarizes the existing methodologies and practices. According to Litterman, PA is the “process in which sources of a portfolio's return are identified and measured.” In practice, portfolio managers rely on either in-house or commercial systems to perform and report PA results.

In traditional PA, asset returns, either domestic or international, are decomposed against a set of factors. This approach breaks down the overall portfolio return into return contributions driven by those factors, any currency contributions based on currency returns (for international portfolios) and return components or contributions driven by whatever is unexplained by those factors. This unexplained return is called by various names including specific return, idiosyncratic return, stock selection, and residual return or contribution. Apart from the selection of the factors and how they are represented, the decomposition of a portfolio's return at any point in time is normally unambiguous. However, when returns are compounded over time, the additive properties of a point in time are lost unless a linking algorithm is employed. There are several known linking algorithms including the Frank Russell methodology (Litterman) and techniques employing log returns.

Factor contributions are computed as the product of factor returns with the portfolio's weighted exposure to the factor. The specific contribution is computed as the total portfolio contribution (e.g., weighted return) minus all the factor contributions. Contributions have properties similar to returns, in that they can describe a contribution at a point in time, or they can be accumulated into a cumulative contribution over time. Indeed, the two terms, contributions and returns, are often used interchangeably not because they are identical but because they share similar properties.

Ideally, over time, the factor contributions of each factor as well as the combined sum of factor contributions should be uncorrelated with the residual contribution.

The difficulties interpreting traditional PA results have been previously identified, and various solutions have been proposed. One solution is described in R. A. Stubbs and V. Jeet, “Adjusted Factor-Based Performance Attribution”, The Journal of Portfolio Management, Special Issue 2016, and U.S. patent application Ser. No. 14/336,123 filed Jul. 21, 2014, which are incorporated by reference herein in their entirety. In this solution, an iterative regression algorithm is used to re-estimate factor returns for a PA such that the magnitude of the beta of the adjusted factor returns to the adjusted specific return is minimized. This process generally reduces the magnitude of the specific contribution, allowing a clearer interpretation of which factors most affected the overall performance. In this approach, a particular adjustment is made to the factor return model based on the particular portfolio being analyzed. This procedure does not make use of FMPs or attempt to create a generalized adjustment of the returns model that would be useful for more than one set of historical portfolio. Furthermore, this method gives no insight into the characteristics of adjustment made. This limits a portfolio manager's ability to derive unifying characteristics about what kind of PA adjustments work best for his or her investment process.

A different approach to portfolio-based and FMP-based PA is described by R. Grinold, “Attribution,” The Journal of Portfolio Management, Vol. 32 No. 2, pp. 9-22, Winter 2006 and R. Grinold, “The Description of Portfolios,” The Journal of Portfolio Management, Vol. 37 No. 2, pp. 15-30, Winter 2011 (the two Grinold publications are hence referred to collectively as “Grinold”); both of the above cited publications are incorporated by reference herein in their entirety. As with the present invention, a set of portfolios such as FMPs are used to decompose a portfolio's performance (e.g., return) and risk in terms of the performance and risk of a set of portfolios, possibly FMPs, and a residual. In Grinold, the analysis devotes significant effort to various correlation coefficients, which could be the cross-sectional, point-in-time correlation coefficients of different portfolios or their variances. While Grinold decomposes performance into the performance of a set of portfolios and a residual, the similarities end at there. In Grinold, there is no systematic attempt to incorporate various restrictions in the construction of the FMPs including the restriction of the universe of assets used to construct the FMP, the rebalancing frequency for the FMPs, as well as various constraints such as long-only or long/short, risk limits, or turnover limits. As is shown with the extensive examples described herein, these additional restrictions are crucial for obtaining FMP-based PAs with actionable insights. Furthermore, although Grinold presents many correlation coefficients, none of them are correlation coefficients based on a time-series of data. Instead, they are all correlation coefficients based on a point-in-time, cross-sectional distribution the portfolios. Grinold provides no data or discussion about how his results would evolve over time.

### SUMMARY OF THE INVENTION

Among its several aspects, the present invention recognizes that existing approaches for factor based performance attribution of historical portfolios suffer from important limitations as addressed in detail above and further below. To the end of addressing such limitations, the present invention provides an entirely new framework for performing PA using FMPs.

One general problem considered by the present invention is the fact that standard PA using off-the-shelf risk models may not include all the relevant factors or the appropriate estimation universe and rebalance frequency used by a portfolio manager.

A further problem considered by the present invention is the fact that often portfolio managers must obey mandated constraints on their portfolio such as being long-only or having a maximum allowable turnover that are not well represented by the FMPs implicit in a linear return model.

A further problem considered by the present invention is that in traditional PA, the magnitude of the factor and residual contributions are often of approximately the same size, and often of different sign; for example, one of them is positive while the other is negative. In theory, the residual contribution is intended to be uncorrelated with the factor contribution. However, in practice, the traditional PA residual contribution is often highly correlated with factor contribution. This unwanted correlation makes it difficult to identify actionable trends in the portfolio investment process. Even if factor and residual contributions are uncorrelated, we may still find factor and residual contributions that are significant but of opposite sign. For instance, this can occur if constraints like long-only requirements significantly impact the mean return one can earn by betting on a particular factor.

One goal of the present invention, then, is to provide a machine capable of producing alternative PA using FMPs as taught further herein.

Another goal of the present invention is to provide portfolio managers the opportunity to add and remove factors from a factor based PA to better match the factors used by a portfolio manager and see the results of such changes. In addition, the present invention aims to allow the PA to use the same estimation universe and rebalance frequency used by the portfolio manager.

Another goal of the present invention is to provide a system in which the factors used in PA can be aligned with the constraints imposed on the portfolio manager.

Another goal of the present invention is to provide a metric that can be used to assess the quality or usefulness of a PA. This metric can be used to guide portfolio managers as they seek more intuitive PA results.

Another goal is to provide improved tools for displaying and comparing PA analysis as addressed further herein. In particular, an improved, interactive tool in a graphical user interface is described in detail that can be advantageously employed by a portfolio manager to create useful PA results.

Another goal is to provide an automated machine for searching for, identifying, and presenting the most intuitive PA results for a particular set of historical portfolios.

Another goal is to allow the construction of a database associating FMP characteristics with particular portfolios or portfolio managers. Such a database would be used for identifying managers with a repeatable ability to successfully invest in a particular set of factors. As one example, a large fund such as a university endowment may be broken into a smaller allocation which will be outsourced for management. The university would look for external money managers with (1) a history of good performance, for example, repeatability of portfolio return, and (2) verifiability of the investing premise or theme, for example, if the portfolio is said to be a growth or value portfolio are the returns produced by that type of investment. If not, the desired diversification of the outsourced investment within the overall university investments may not be achieved. The present invention provides a useful tool for making such evaluations.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a standard PA report for a portfolio;

FIG. 2 shows a graphical representation of the exposure and return associated with a value factor over time;

FIG. 3A shows a user computer system which may be suitably adapted and utilized in conjunction with the present invention;

FIG. 3B shows a networked server system in accordance with the present invention with which the user computer of FIG. 3A may suitably be employed;

FIG. 4 shows two different FMP-based, factor-based PAs for a profitability portfolio, and a standard PA and the other a PA determined in accordance with the present invention;

FIG. 5 shows two different FMP-based, factor-based PAs for an earnings yield portfolio illustrating a context in which the present invention is advantageous;

FIG. 6 shows two different FMP-based, factor-based PAs for a medium-term momentum portfolio illustrating further context in which the present invention is advantageous;

FIG. 7 shows two different FMP-based, factor-based PAs for a profitability portfolio using two different sets of factors from different factor risk models;

FIG. 8 shows cumulative returns for three different profitability FMPs, each constructed over a different universe of stocks;

FIG. 9 shows cumulative returns for three different low volatility FMPs, each constructed over a different universe of stocks;

FIG. 10 shows two different FMP-based, factor-based PAs for a profitability portfolio using two different asset universes to construct the FMPs;

FIG. 11 shows cumulative returns for three different medium-term momentum FMPs, each constructed over a different universe of stocks;

FIG. 12 shows two different FMP-based, factor-based PAs for a medium-term momentum portfolio using two different asset universes to construct the FMPs;

FIG. 13 shows a table of correlations of contributions between different FMPs;

FIG. 14 shows a table of annualized returns for different FMPs;

FIG. 15 shows two different FMP-based, factor-based PAs for a profitability portfolio: a long-short FMP and a long-only FMP;

FIG. 16 shows cumulative returns for three different earning yield FMPs, each constructed with different sets of constraints;

FIG. 17 shows cumulative returns for three different low volatility FMPs, each constructed with different sets of constraints;

FIG. 18 shows the correlations of FMP contributions for different factors and FMP constraints;

FIG. 19 shows the annualized returns of FMP contributions for different factors and FMP constraints;

FIG. 20 shows two different FMP-based, factor-based PAs for a profitability portfolio: a long-short FMP and a long-only FMP;

FIG. 21 shows different FMP-based, factor-based PAs for a profitability portfolio, the FMPs satisfying different constraints;

FIG. 22 shows different FMP-based, factor-based PAs for an earnings yield portfolio, the FMPs satisfying different constraints;

FIG. 23 shows the correlation of the factor and specific contributions for different long-only FMPs;

FIG. 24 shows the annualized return of different long-only FMPs;

FIG. 25 shows the distribution of the Russell 3000 assets as a function of quintiles of profitability and value;

FIG. 26 shows the distribution of active holdings for different quintiles of profitability and value;

FIG. 27 shows FMP-based, factor-based PAs for a profitability portfolio with different FMP rebalancing frequencies;

FIG. 28 shows FMP-based, factor-based PAs of a medium-term momentum portfolio with different FMP rebalancing frequencies;

FIG. 29 shows an exemplary graphical interface for iterative and automatic PA analysis; and

FIG. 30 shows a computer implemented method in accordance with the present invention for interactively displaying factor-mimicking portfolio (FMP)-based performance attribution (PA) for a set of historical investment portfolios on a graphical user interface which displays graphs of residual performance contributions not explained by FMPS.

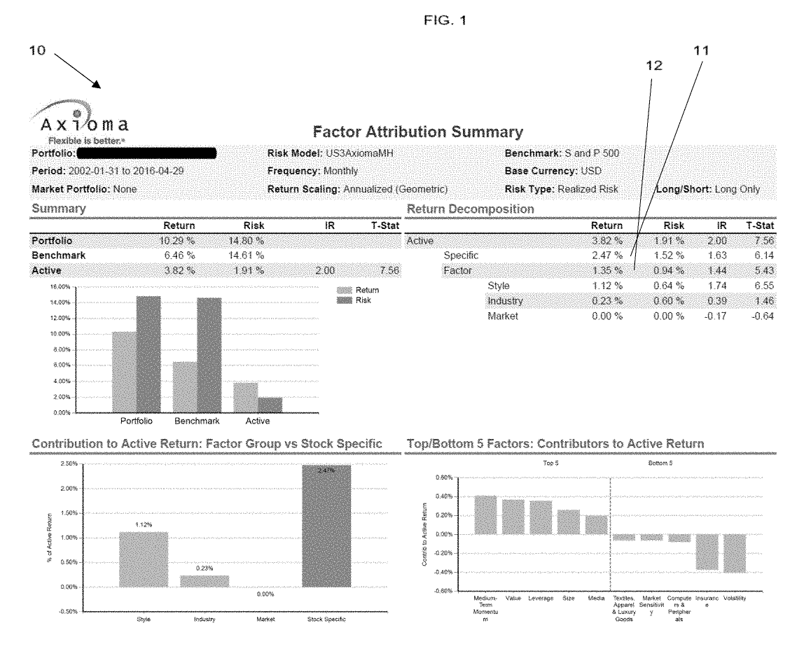

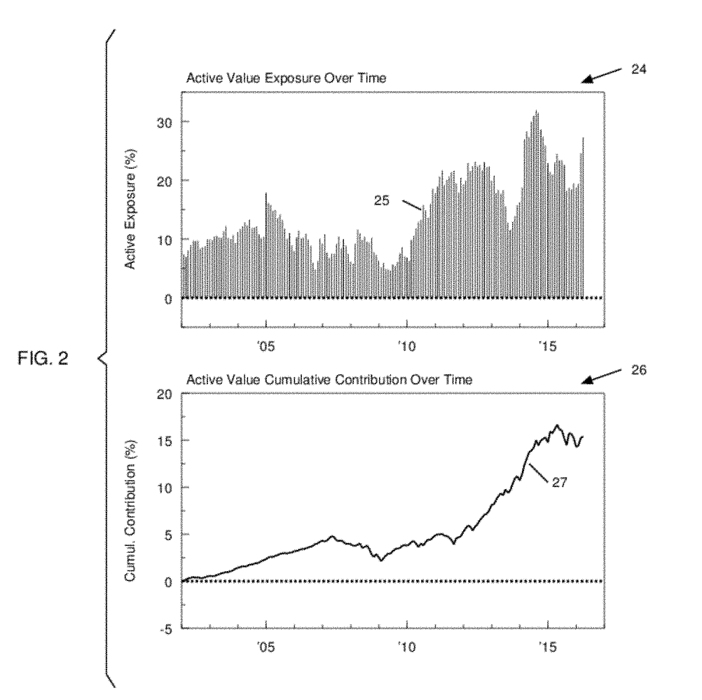

### DETAILED DESCRIPTION

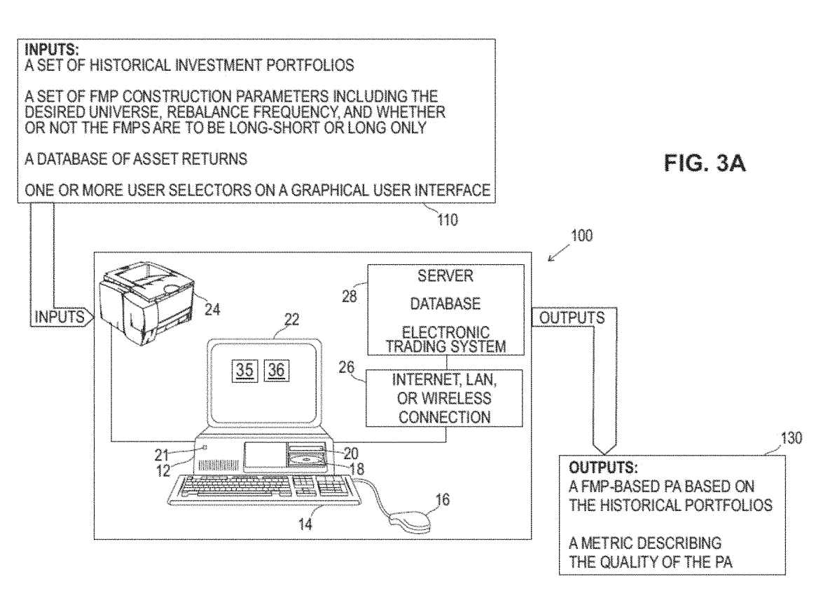

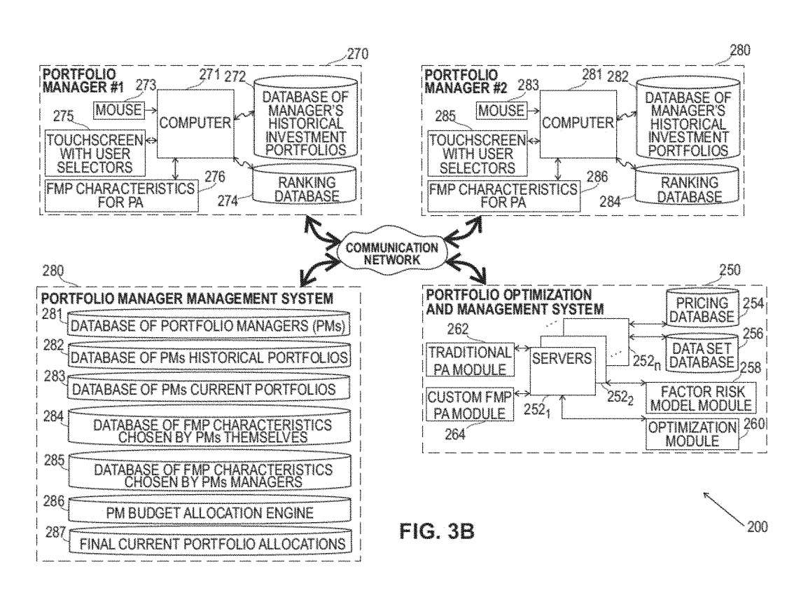

FIG. 3A shows a block diagram of a computer system 100 which may be suitably adapted and employed as one implementation of the present invention. System 100 is implemented as a desktop computer or a mobile computing device 12 including one or more programmed processors, such as a personal computer, workstation, or server. One implementation of the system of the invention is as a personal computer or workstation that connects to a server, database, or an electronic trading system 28, as well as other user computers through an Internet, local area network (LAN) or wireless connection 26. The server, database, or electronic trading system 28 or LAN may also connect to a portfolio optimization and management system or a database that stores and manages investment portfolios. In this embodiment, both the computer or mobile device 12 and server, database, or electronic trading system 28 run software that when executed enables the user to input instructions, make user selections, and calculations in accordance with the present invention as described further herein to be performed by the computer or mobile device 12, send the input for conversion to output at the server, database, or electronic trading system 28, and then display the output on a graphical user interface display, such as display 22, or print the output, using a printer, such as printer 24, connected to the computer or mobile device 12. The output could also be sent electronically through the Internet, LAN, or wireless connection 26. In another embodiment of the invention, the entire software is installed and runs on the computer or mobile device 12, and the Internet connection 26 and server, database, or electronic trading system 28 are not needed.

As shown in FIG. 3A and described in further detail below, the system 100 includes software that is run by the central processing unit of the computer or mobile computing device 12. In one embodiment, system 100 communicates with an optimization and management system to license and download application software to perform the processes and analyses described further below. A file transfer protocol (FTP) high speed download transfer site is established and the software is downloaded from the system. This software customizes the system 100 and transforms the system into a special purpose computer providing unique functionality as addressed further herein. The computer or mobile device 12 may suitably include a number of input and output devices, including a keyboard 14, a mouse 16, CD-ROM/CD-RW/DVD drive 18, disk drive or solid state drive 20, monitor 22 which may be a touchscreen, and printer 24.

The mouse 16 and keyboard 14 can be used to select displays to be displayed on and make selections to be acted upon utilizing the graphical user interface display 22 and monitored by the computer or mobile device 12 as addressed further below. As one example, user selector 35 may be utilized by the user to select from among choices such as, long only versus long and short, a maximum FMP risk limit, a maximum FMP turnover limit, a rebalance frequency, an FMP universe of potential investments, and the like. User selector 36 may be utilized by the user to select a particular portfolio or portfolios from the set of historical investment protfolios for further analysis. For mobile devices and other suitable devices, the user selections may be input using a touch-screen display. In addition, the server, database, or electronic trading system 28 or LAN 26 or electronic trading system or portfolio database may also monitor the interaction with the graphical user interface 22, respond to user indications from the mouse 16 or keyboard 14, touchscreen, and so on.

The computer or mobile device 12 may also have a USB connector 21 which allows external hard drives, flash drives and other devices to be connected to the computer or mobile device 12 and used when utilizing the invention. It will be appreciated, in light of the present description of the invention, that the present invention may be practiced in any of a number of different computing environments without departing from the spirit of the invention so long as the transformative aspects of the present invention are employed therein. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as cell phones, tablets and e-readers such as an IPad™, IPhone™, IPod™, Blackberry™, Treo™, or the like.

One embodiment of the invention has been designed for use on a stand-alone personal computer running Windows 10. Another embodiment of the invention has been designed to run on a Linux-based server system. The present invention may be coded in a suitable programming language or programming environment such as Java, C++, Excel, R, Matlab, Python, etc.

According to one aspect of the invention, it is contemplated that the computer or mobile device 12 will be operated by a user in an office, business, trading floor, classroom, or home setting.

As illustrated in FIG. 3A, and as described in greater detail below, inputs 110 may suitably include a set of historical investment portfolios; a set of FMP construction parameters including the desired universe, rebalance frequency, and whether or not the FMPs are to be long-only; a database of asset returns; and one or more user selectors residing within a graphical user interface.

As further illustrated in FIG. 3A, and as described in greater detail below, the system outputs 130 may suitably include an FMP-based PA of the historical portfolios; and a metric describing the quality of the PA.

The output information may appear on the graphical user interface display screen of the monitor 22 or may also be printed out at the printer 24. The output information may also be electronically sent to an electronic trading platform or a database of PA results. The output information may also be electronically sent to an intermediary for interpretation. Other devices and techniques may be used to provide outputs, as desired.

Customized hardware and software to improve the interaction between a portfolio manager, a portfolio optimization and management system, and a portfolio manager management system is one aspect of the present invention. As further illustrated in one embodiment of the present invention shown in FIG. 3B, a further customized hardware and software system 200 is provided. FIG. 3B shows a networked system 200 in which a portfolio manager management system 280 communicates utilizing a network communication system 240 with a portfolio optimization and management system 250 and a portfolio manager user system 270 used by a portfolio manager or the like. Computer system 100 of FIG. 3A is one suitable example of a system which may be employed as the user system 270. An electronic trading platform (not shown) may receive bids and asks directly from a trader utilizing user system 270 or through the system 250. The user system 270 also comprises a user computer 271 with a graphical user interface, a mouse 273 as well as a touch screen 275 displaying user selectors, such as selectors 35 and 36 addressed above in connection with FIG. 3A. While a single user computer 271 is shown for ease of illustration, it will be recognized that a large number of computer terminals of a large plurality of different trading entities will typically be employed. In addition, the portfolio manager user system saves the FMP characteristics for PA selected by the portfolio manager (PM).

A portfolio manager user system 270 is utilized to evaluate a number of different historical investment portfolios. These results can be electronically stored in a database of manager's results 272. Strategies for employing quantitative metrics that describe the advantages of each portfolio may be generated as discussed further herein. These quantitative metrics may change as updated or further historical investment portfolios are obtained. When more than one historical portfolio is considered, a ranking of the portfolios may be advantageously made and displayed as addressed further herein. Alternatively, the metrics and rankings may be transmitted to a ranking database 274 for storage. This database 274 associates FMP characteristics with particular portfolios or portfolios managers as addressed further herein.

As one example of how a portfolio manager may suitably evaluate a historical portfolio, the user system 270 is used to communicate through the communication network 240 with a portfolio optimization and management system 250. System 250 comprises plural high speed servers 252₁, 252₂, . . . , 252ₙ, a pricing database 254, a dataset database 256, a factor risk model module 258, an optimizer module 260, software 262 to construct and save traditional PA results and software 264 to construct and save FMP-based PA results. While various modules and engines discussed above may be implemented in software operating on a processor or server, it will be recognized that they may be implemented as a combination of software and hardware or principally as hardware, such as an array of field programmable arrays (FPGAs) or application specific integrated circuits (ASICs) to implement an FMP-based performance attribution framework of the present invention for use in analyzing and improving portfolios.

As shown, the portfolio manager management system 280 will be utilized to aggregate and manage the investment budget allocation to each PM. The system comprises a database of portfolio managers 281, and a database of PMs historical portfolios 282, a database of PMs current portfolios 283, and a database of FMP characteristics chosen by the PMs. As part of the allocation of the investment budget across more than one PM, the portfolio manager management system 280 also has a database of FMP characteristics chosen by the mangers of the PMs 285. These characteristics apply across different PMs so that their aggregate contributions could be effectively evaluated. This type of allocation is important in instances where the aggregate positions of more than one PM are best explained with a set of FMP characteristics that are different than the FMP characteristics that worked best for individual PMs.

The portfolio manager management system 280 also has a PM budget allocation engine 286 for determining how to allocation available investment resources between the PMs, as well as a database 287 of the final, current, aggregate portfolio allocations which combines all the PMs individual portfolios into a composite portfolio. In some cases, the only trades submitted to an electronic trading platform would be these final allocations.

Commonly, models like the model of equation (1) above are estimated using a fundamental approach, where the modeler specifies the exposure matrix X, and then estimates the factor returns f via cross-sectional regression. In this case, the factor returns can be thought of as the returns of portfolios called factor mimicking portfolios (FMPs).

Specifically, if the cross-sectional regression is weighted by a matrix W, then

f=(X^{T}WX)⁻¹X^{T}Wr (3)

In other words, the factor returns are the returns of the portfolios captured by the columns of the matrix WX(X^{T}WX)⁻¹.

Now consider a portfolio of the form w=WX(X^{T}WX)⁻¹δ, in other words a linear combination of FMPs. That is, δ is a row vector giving the weights for each FMP in the portfolio w. If factor returns are estimated using cross-sectional regression with weights W, then a PA of the form of equation (2) has the following properties:
The exposures of the portfolio to the factors are w^{T}X=δ.
The factor contribution is δ^{T}f
The specific contribution is zero, since

w^{T}(r−Xf)=δ^{T}(X^{T}WX)⁻¹X^{T}Wr−δ^{T}(X^{T}WX)⁻¹X^{T}WXf=0 (4)

In other words, attribution on a linear combination of FMPs leaves no residual.

Now, consider an alternative perspective on factor PA where it is sought to maximally explain the (active) portfolio as a linear combination of FMPs. In this case, rather than use the FMPs that reproduce the factor returns obtained by linear regression, an alternative set of FMPs is produced by solving a problem of the form

min u^{T}Q u (5)

w=WXλ+u (6)

In other words, the actual portfolio, w, is described as a linear combination of WX plus a residual, u, where the residual minimizes the scalar quantity u^{T}Qu.

The optimal solution to (5) and (6) is given by

λ=(X^{T}WQWX)⁻¹X^{T}WQW (7)

If the inverse of the regression weights equals the variance, in other words if Q=W⁻¹, then it is found that λ=(X^{T}WX)⁻¹X^{T}w. This implies that

r^{T}w=r^{T}WXλ+r^{T}u

=r^{T}WX(X^{T}WX)⁻¹X^{T}w+r^{T}u

=f^{T}Xw+r^{T}u

=w^{T}XF+w^{T}ε (8)

In other words, for an appropriately chosen Q, this approach is equivalent to the usual factor based PA given in equation (2).

However, by viewing PA from this perspective, additional flexibility is introduced as it is now possible to explain the portfolio in terms of portfolios other than the FMPs implied by the cross-sectional regression of the fundamental model. Furthermore, a full risk model can be chosen to represent Q, rather than the proxies obtained by the inverse of the regression weights.

More generally, solving

min u^{T}Qu (9)

w=Hλ+u (10)

and, given a solution to this optimization, the portfolio return can be decomposed as

w^{T}r=r^{T}Hλ+r^{T}u (11)

With this decomposition, the first term on the right-hand side of equation (11), r^{T}Hλ, is the factor component, and the second term on the right-hand side of equation (2), r^{T}u, is the specific component.

In traditional factor based PA, H is the matrix of FMPs and Q=W⁻¹. However, the FMPs in H can be replaced with factor portfolios that more closely reflect the limitations imposed on the strategy that produced w.

Next, the approach of the present invention establishes that unconstrained optimal mean-variance portfolios, herein termed MVO portfolios, can be perfectly explained by the factor based attribution of an appropriately constructed returns model. This insight is motivated by that fact that each FMP is itself an optimal solution to a very specific mean-variance optimization (MVO) problem. More precisely, the FMP for the i-th factor is an optimal solution to:

min h^{T}W⁻¹h (12)

X^{T}h=eᵢ (13)

where eᵢ is a vector with a one in the i-th position and zeros elsewhere. In other words, the FMP is a minimum risk portfolio that has unit exposure to the factor in question, and no exposure to any other factors in the model.

Now a generic, unconstrained mean-variance optimization (MVO) is examined:

max α^{T}h (14)

(h−b)^{T}Q(h−b)≤r² (15)

where b is a benchmark. In other words, alpha, α, is maximized with a constraint on active risk. The solution, h, of (14) and (15) is the unconstrained, long-short, MVO portfolio that tilts on α. The optimal active portfolio is a multiple of Q⁻¹α. Now suppose that Q=XΩX^{T}+Δ and α=Xθ, i.e. the alpha is a linear combination of factors in the risk model. In this case, it can be shown that

Q⁻¹ α

=(Δ⁻¹−Δ⁻¹X(X^{T}Δ⁻¹X+Ω⁻¹)⁻¹X^{T}Δ⁻¹)α

=Δ⁻¹α−Δ⁻¹Xλ

=Δ⁻¹Xθ−Δ⁻¹Xλ

=Δ⁻¹X(θ−λ) (16)

In other words, if W=θΔ⁻¹, then the optimal active portfolio is a linear combination of FMPs of a regression weighted by the inverse of specific variances in the risk model. Alternatively put, if H=Δ⁻¹X in (9) and (10), then the portfolio return can be explained exactly, and u=0 yielding an attribution with no residual.

Adding constraints to the optimization causes this simple relationship to break down, but it motivates the replacement of usual FMPs, produced by (12) and (13), with factor portfolios that also reflect the additional constraints.

For instance, if the portfolio construction is bound by long-only constraints, then it stands to reason that this restriction should be accounted for in the definition of a factor portfolio as well. Hence, (12) and (13) can be replaced with

min h^{T}Δh (17)

X^{T}h=eᵢ (18)

h≥−b (19)

The constraint h≥−b follows from the fact that if the portfolio must be long-only, then the active portfolio cannot underweight any asset more than its weight in the benchmark. Unfortunately, this problem may not always have a feasible solution, so instead exposure to the required factor subject to a risk constraint is maximized:

max Xᵢ^{T}h (20)

h^{T}Qh≤r² (21)

Xⱼ^{T}h=0∀j≠i (22)

h≥−b (23)

By replacing some of the usual FMPs in the matrix H in equations (9) and (10) with FMPs resulting from equations (20)-(23), an attribution can be computed constrained to these long-only FMPs and the effect of having these constraints on the portfolio construction strategy can be advantageously addressed.

As one example, the following sequence of steps is employed. First, equations (20)-(23) are solved to determine a set of h's which are FMPs. Second, these h's or FMPs are combined to form the matrix H in equations (9) and (10), which are solved to determine the decomposition, which includes the specific return u. Finally, the portfolio's return is decomposed as shown in equation (11). This sequence of steps is performed at every time period in the attribution to produce a factor/specific decomposition over time. The contributions over time are then linked to create PA results. This approach provides an advantageous alternative FMP-based performance attribution.

As seen in the following quantitative examples, by thinking about factor-based PA as a framework that explains a portfolio's return using a set of FMPs derived by a generalized, but readily solved optimization problem instead of as a linear combination of fixed factor returns and exposures, flexibility is gained to clearly identify which elements of a particular investment strategy added value, such as increasing the return to the investment process.

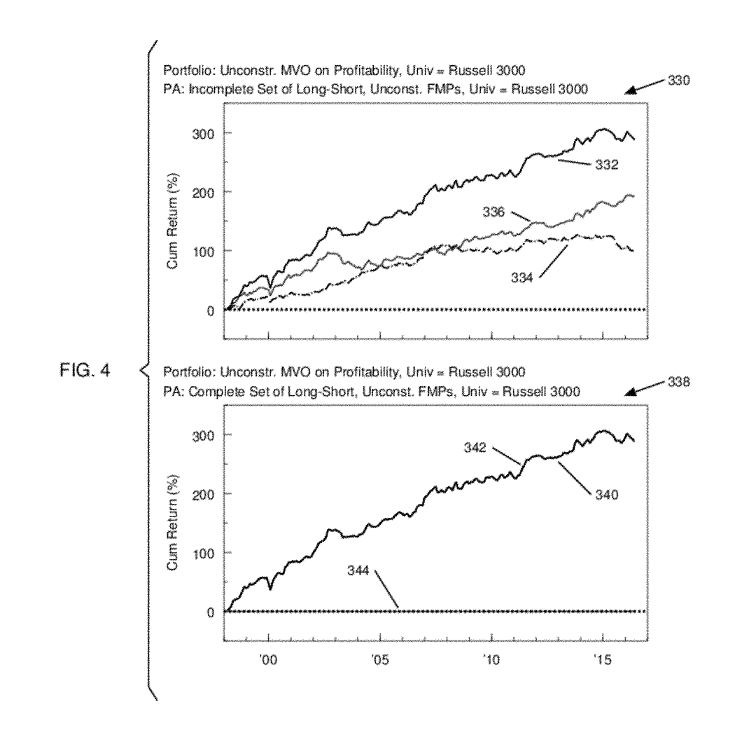

Charts 330 and 338 in FIG. 4 show two different factor-based PAs for a portfolio that tilts heavily on a factor describing the profitability of each company. The portfolio is the unconstrained, long-short MVO portfolio tilting on profitability, as described by equations (14) and (15). The universe of stocks for this problem consists of those equities in the Russell 3000 equity index. In chart 330, a standard PA is performed, using a return model in which only some of the components of the true profitability signal are present. That is, for the PA in chart 330, the factors used for the PA do not fully represent the signal used to construct the underlying portfolio. The dark line 332 shows the cumulative active return of the portfolio, while dotted line 334 shows the decomposed factor component cumulative return, and light grey line 336 shows the cumulative specific return.

These standard decomposition results, represented by curves 334 and 336, are approximately the same magnitude and sign, and together they add up to the full active return, 332. However, since the PA factors do not fully represent the signal used to construct the portfolio, it is reasonable to ask if the specific return, which is significant, truly represents specific return or, alternatively, is simply the result of misrepresenting the signal.

In chart 338, an alternative PA is performed in accordance with the present invention using a return model that has factors that fully represent the profitability signal used to construct the portfolio. The dark line is indicated by two numbers, 340 and 342, because, in fact, two lines are drawn on top of each other. That is, line 340, which is the cumulative active return of the portfolio and line 342, which is the factor component, lie on top of each other and are indistinguishable in the chart. Of course, when the factor component represents the active return exactly, the specific component, 344, is identically zero.

These results indicate that the standard PA with missing factors does not fully attribute performance to the factors, leaving a significant specific, residual, unexplained return. It is generally preferable to use an alternative PA that includes the full set of factors relevant to the portfolio construction. In this case, it is possible to make the residual, specific, unexplained return identically zero. Selecting the PAs and displaying the charts for those selected PAs as addressed above in connection with FIG. 4 provides the user with a new and useful tool to identify the sources that best explain the return of the portfolio.

There are many possible metrics that may be used to quantify the quality of PAs. These include
1) The correlation of the period factor and specific returns measures how much of the specific return could still be explained by some combination of the factor returns;
2) Computing the ratio of the absolute value of the specific contribution to the factor contribution gives a sense of the magnitude of the specific contribution relative to the factor contribution; and
3) The volatility of specific returns could be used, or the mean value of the specific returns, or the cumulative specific return, all as a measure of the absolute magnitude of the specific contribution.
   For all of these metrics, a high quality PA is represented by a quality metric with smaller absolute magnitude. The smaller the magnitude of the PA quality metric, the better the PA. Of course, alternative quality metrics may indicate better PAs with larger quality metrics. Some of these metrics are illustrated below when evaluating some of the PA results in later portions of this application. Many PA quality metrics are possible. The invention may be practiced with alternative PA metrics without deviating from the invention described here.

Note that these results do not imply that the standard PA results are wrong. Those results are correct. The point being made here is that they are not a helpful decomposition of the portfolio's performance, either for convincing investors of the value of active management or in identifying constructing change to an investment process that can be used to improve the investment process.

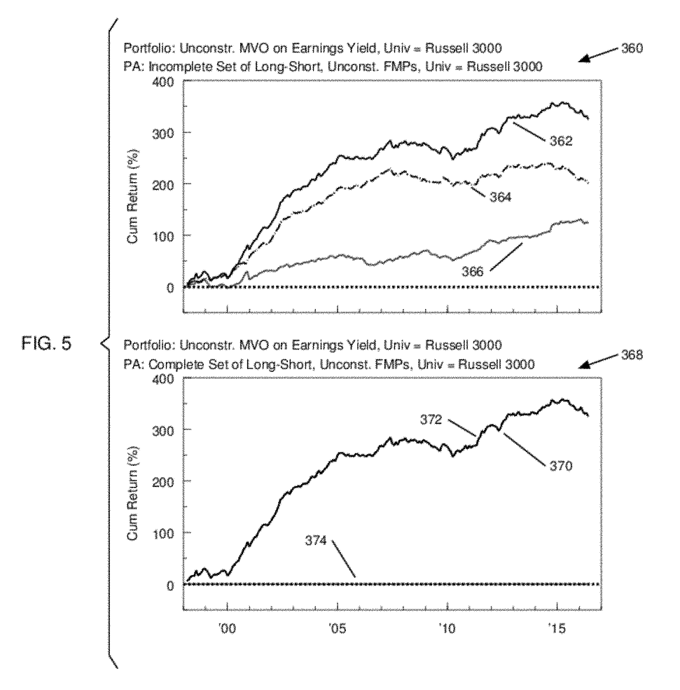

FIG. 5 is similar to FIG. 4 except in this case the factor tilt is on an earnings yield factor instead of profitability. Charts 360 and 368 in FIG. 5 show the two different factor PAs for a portfolio that is an unconstrained, mean-variance MVO portfolio tilting on an earnings yield factor. The PA is performed from 1998 to the end of June 2016. In chart 360, a standard PA is performed, using a return model in which earnings yield is combined with book-to-price to create a value signal. That is, for the PA in chart 360, the factors used for PA do not fully represent the signal used to construct the underlying portfolio. The dark line 362 shows the cumulative active return of the portfolio, while dotted line 364 shows the decomposed factor component cumulative return and light grey line 366 shows the cumulative specific return. These standard decomposition results, curves 364 and 366, are similar to those in FIG. 4. In this case, the factor contribution is about twice as large as the specific contribution, and both are positive. However, since the PA factors do not fully represent the signal used to construct the portfolio, it is reasonable to ask if the specific contribution, which is significant in that it is about half as large as the factor contribution, truly represents specific contribution or, alternatively, is simply an artifact of misrepresenting the signal.

In chart 368, an alternative PA in accordance with the present invention is performed using a return model that has factors that fully represent the earnings yield signal used to construct the portfolio. The dark line is indicated by two numbers, 370 and 372, because, in fact, two curves are drawn on top of each other. That is curve 370, which is the cumulative active contribution of the portfolio and curve 372, which is the factor component, are indistinguishable. Of course, when the factor component represents the active contribution exactly, the specific component 374 is identically zero.

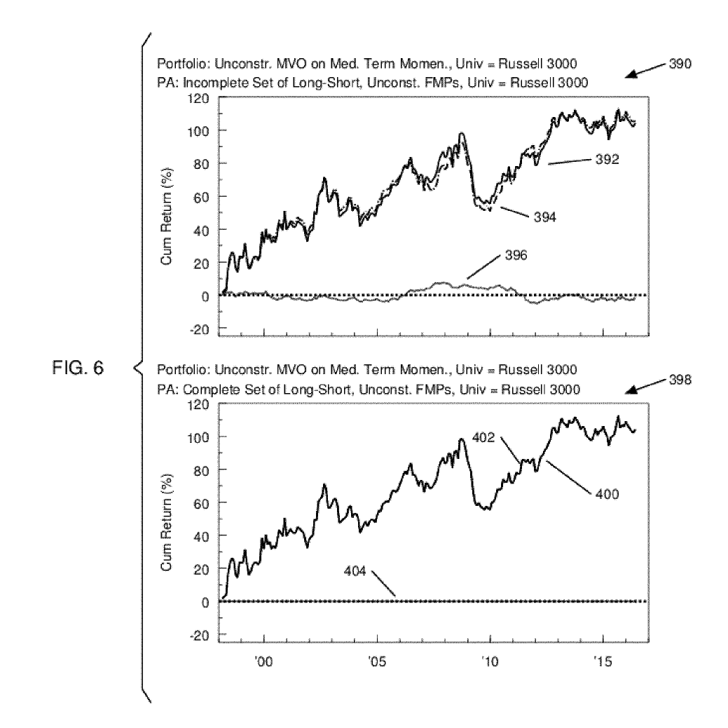

As with the results in FIG. 4, these results indicate that the standard PA with missing factors does not fully attribute performance to the factors, leaving a significant specific, residual, unexplained return or contribution. Selection of these PAs and display of the results as addressed above provides a useful tool. FIG. 6 is similar to FIGS. 4 and 5 except in this case the factor tilt is on a medium-term momentum factor instead of either earnings yield or profitability. Charts 390 and 398 in FIG. 6 show the two different PAs for a portfolio which is the unconstrained, long-short, mean variance (MVO) medium-term momentum portfolio. The PA is performed from 1998 to the end of June 2016. In chart 390, a standard PA is performed, using a return model in which a definition of medium-term momentum is used that is slightly different from the medium-term momentum signal that the portfolio tilts on. In practice, it is quite common for there to be slightly different factor signals such as slightly different definitions of medium-term momentum. For the PA in chart 390, the factors used for that PA do not fully represent the signal used to construct the underlying portfolio. The dark line 392 shows the cumulative active return of the portfolio, while dotted line 394 shows the decomposed factor component cumulative return and light grey line 396 shows the cumulative specific return.

Unlike in FIGS. 4 and 5, these standard decomposition results 394 and 396 already show a factor contribution that is quite similar but not identical to the active return, with a correspondingly small specific return 396. In chart 398, an alternative PA in accordance with the present invention is performed using a return model that has factors that fully represent the medium-term momentum signal used to construct the portfolio. The dark line is indicated by two numbers, 400 and 402, because, in fact, the two curves are identical. The specific component, 404, is identically zero.

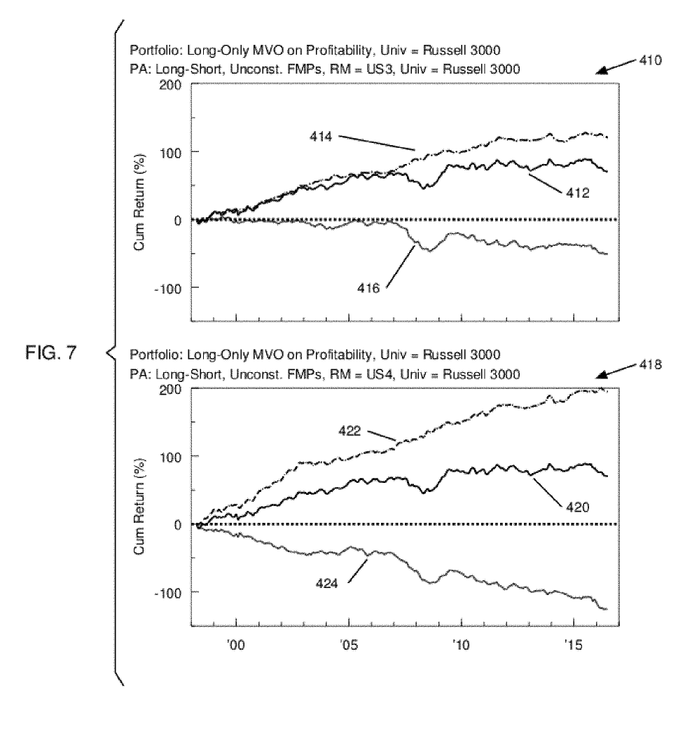

Here it is seen that for some portfolios, the standard PA can produce results in which the specific component is relatively small in comparison with the factor contribution. Again, the displayed information for the selected PAs for evaluation by a user is intuitively useful to the user. This is true for the selections and displays of the figures which follow as well. Charts 410 and 418 in FIG. 7 show two different factor PAs for an unconstrained, long-only, MVO profitability portfolio. Whereas in FIG. 4, the portfolio was a long-short unconstrained MVO portfolio tilting on profitability, here in FIG. 7, the portfolio is a long-only MVO portfolio tilting on profitability. The PA is performed from 1998 to the end of June 2016. In chart 410, a standard PA is performed using Axioma' s Fundamental Factor, Medium Horizon, Equity Risk Model Version 3 (AXUS3-MH). In chart 418, Version 4 of Axioma's Fundamental Factor, Medium Horizon, Equity Risk Model (AXUS4-MH) is used. In this case, AXUS4-MH contains the profitability factor explicitly. The factors in AXUS3 only approximate the profitability factor. In chart 410, the dark line 412 shows the cumulative active return of the portfolio, while dotted line 414 shows the decomposed factor component cumulative return and light grey line 416 shows the cumulative specific return.

The decomposition results using AXUS3-MH, illustrated by curves 414 and 416, are intuitive, in that the factor contribution 414 dominates the attribution, and the specific contribution 416 is relatively small. If a PA quality metric were employed to evaluate this result, the metric would produce a relatively small number indicating a useful PA.

In chart 418, the PA using AXUS4-MH shows large factor and specific contributions of different signs. The active return is shown by the dark line 420. The factor contribution is shown by the dotted line 422. The specific return is shown by the light grey line 424.

Here it is seen that the introduction of a long only constraint into the portfolio can change the PA results dramatically. Here, the model that only approximates the factor tilt does a better job attributing the return to factors than the model that contains the factor explicitly. In other words, a PA quality metric evaluating the PA in 410 would be of smaller magnitude than the PA quality metric evaluation, the PA in 418. This result is an example of two wrongs (e.g., discrepancies) making a right (counter-acting each other). Clearly, with such a wide range of results, it can be hard to come to reliable conclusions of what to expect with any given PA. Indeed, a flexible interactive PA that automatically enables portfolio managers to seek a defensible and intuitive PA is clearly required. This is a tool that has been desired but missing from the arsenal of portfolio managers' tools. The present invention provides a framework for creating a tool to fill this gap. One aspect of the present invention is the automation of FMP-based PA to obtain PAs with advantageous PA quality metrics. The new analysis tools provided by the present invention are particularly helpful for complex signals, portfolios, and PA results such as those illustrated in FIG. 7 in which a portfolio manager's intuition on which FMPs to use may not be accurate.

Once portfolio managers have a PA of their performance, the standard investment advice is to identify those factors that have performed well and, going forward, increase the portfolio exposures to those factors that worked well. In addition, the PA is used to identify those factors that have not performed well and, going forward, the portfolio manager will try to reduce his or her exposure to those factors. Changes to an investment strategy depend crucially on whether or not a PA indicates a factor is over or under-performing. It is therefore also crucial to have a PA in which the performance of the factors indicated is unambiguous—that is, in which the PA quality metric is low, indicating a high quality PA. When the PA quality metric is high, then there is ambiguity about whether the performance is driven by factor contributions or specific contributions. This uncertainty leads to ambiguity about potential changes to an investment strategy based on the PA. A tool that reliably produces a high quality PA is therefore advantageous to portfolio managers wishing to improve their performance.

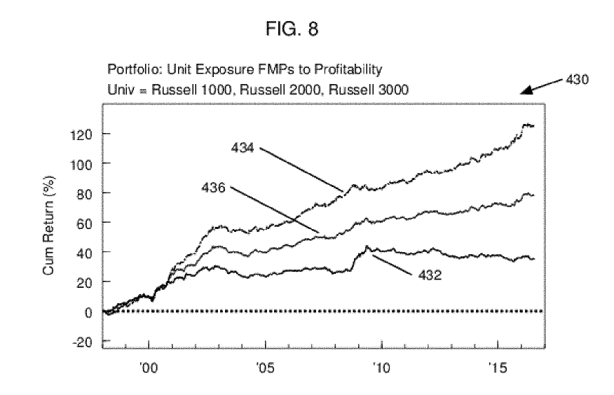

Chart 430 in FIG. 8 shows how the return of profitability FMP changes with the universe over which it is estimated. In each case, the FMP is long-short and unconstrained. Curve 432 is the return of the profitability FMP using the assets in the Russell 1000 equity index. Curve 434 is the return of the profitability FMP using the assets in the Russell 2000 equity index. Curve 436 is the return of the profitability FMP using the assets in the Russell 3000 index, which is the union of the Russell 1000 and Russell 2000 universes. As a result, the return of the profitability FMP for the Russell 3000 universe falls between those of the Russell 1000 and Russell 2000 returns. These results show that the FMP universe can make an important difference in the FMP return.

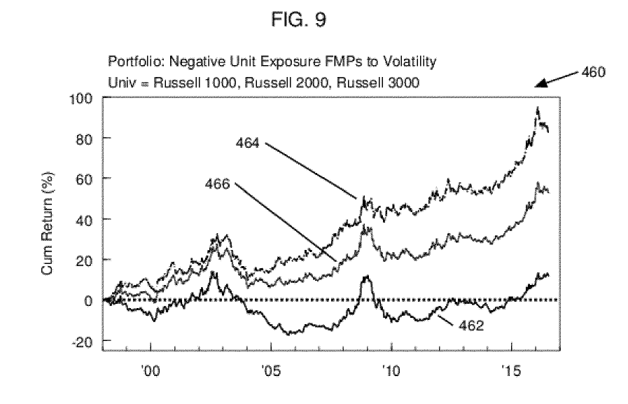

Chart 460 in FIG. 9 shows the cumulative factor return of three different, long-short, unconstrained FMPs that have a negative unit exposure to a volatility factor for three different universes. Curve 462 is the return of the low volatility FMP using the assets in the Russell 1000 equity index. Curve 464 is the return of the low volatility FMP using the assets in the Russell 2000 equity index. Curve 466 is the return of the low volatility FMP using the assets in the Russell 3000 equity index, which is the union of the Russell 1000 assets and the Russell 2000 assets. A key take-away from these results is that, once again, the cumulative FMP returns can differ substantially depending on the universe over which the FMPs are constructed, and these differences will be reflected in PA results that use FMPs constructed over different universes.

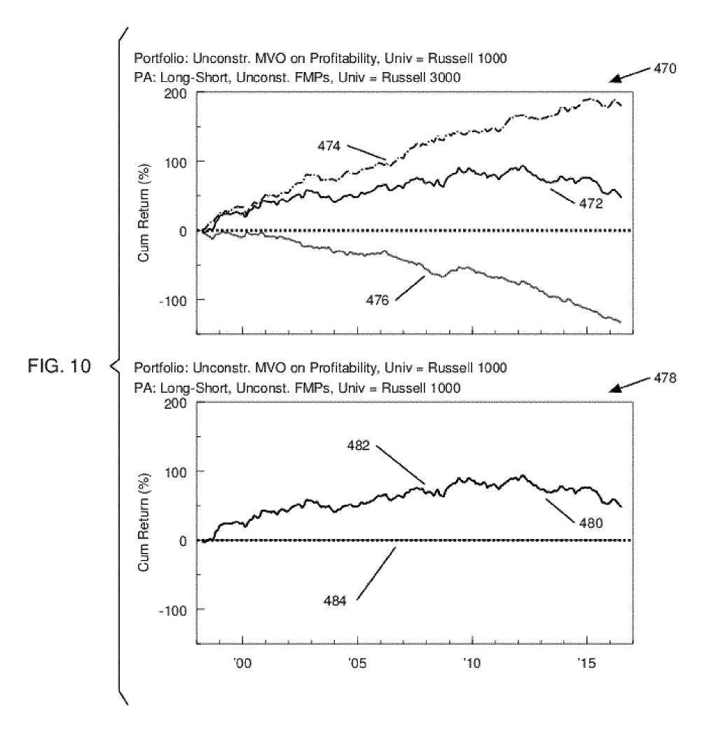

Charts 470 and 478 in FIG. 10 show two different PAs based on FMPS derived using the Russell 1000 asset universe and the Russell 3000 asset universe. For this data, we construct long-short mean-variance, unconstrained portfolios tilting on profitability constructed over the Russell 1000 universe. In chart 470, curve 472 is the active return of those portfolios. Curve 474 is the factor contribution computed using FMPs constructed over the Russell 3000 universe and curve 476 is the specific contribution computed using the Russell 3000 FMPs. In this analysis, the universe used to construct the portfolio (Russell 1000) is different than the universe used to construct the FMPs used for attribution (Russell 3000). With this mismatch, both the factor contribution and the specific contribution are large in magnitude but of opposite signs. As previously noted, this situation poses a problem in terms of trying to understand which source—factor or specific—best explains the active return. In other words, a PA quality metric would indicate a mediocre quality for this PA.

In chart 478, curve 480 is the same active return shown by curve 472 in chart 470. In this case, however, PA was performed using FMPs constructed over the Russell 1000 universe, the same universe used to construct the long-short mean-variance, unconstrained, profitability portfolios. In this case, the factor contribution 482 is identical to the active return 480, and the specific contribution 484 is identically zero. This kind of result is easier to interpret than the PA performed in chart 470. A PA quality metric would indicate a high quality PA.

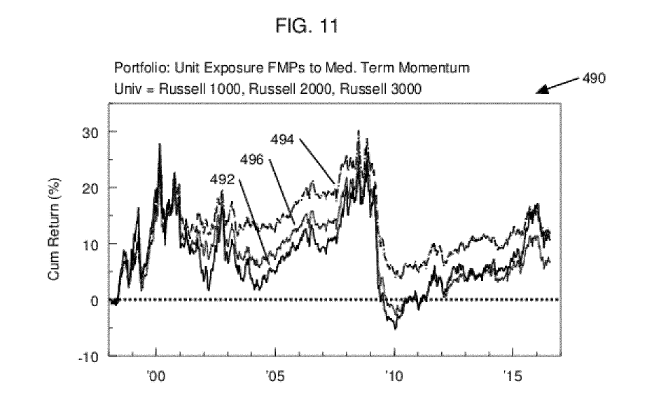

Chart 490 in FIG. 11 shows an example of how the return of a long-short, unconstrained medium-term momentum FMP can change with the universe over which it is estimated. Curve 492 is the return of the FMP using the assets in the Russell 1000 equity index. Curve 494 is the return of the FMP using the assets in the Russell 2000 equity index. Curve 496 is the return of the FMP using the assets in the Russell 3000 index, which is the union of the Russell 1000 and Russell 2000 universes. As a result, the return of the medium-term momentum FMP for the Russell 3000 universe falls roughly between those of the Russell 1000 and Russell 2000 returns. These results show that the impact of the universe on the FMP returns can vary drastically across factors, with some factors showing big differences across universes, while others behave similarly for different universes.

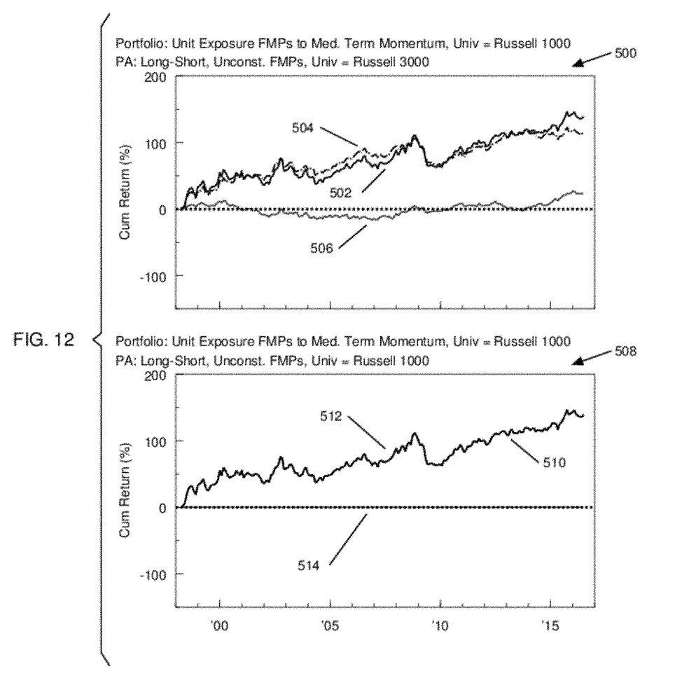

Charts 500 and 508 in FIG. 12 show two different PAs for long-short, mean-variance, unconstrained portfolios tilting on medium-term momentum constructed with the Russell 1000 universe. In chart 500, curve 502 is the active return of the portfolios. Curve 504 is the factor contribution computed using FMPs constructed over the Russell 3000 universe and curve 506 is the specific contribution computed using the Russell 3000 FMPs. In this analysis, the universe used to construct the portfolio (Russell 1000) is different from the universe used to construct the FMPs used for attribution (Russell 3000). Despite this mismatch, the factor contribution almost completely captures, in other words explains or matches the active return of the portfolio, while the specific contribution is small throughout. A PA quality metric would indicate a high quality for this PA. One could anticipate this result from the medium-term momentum FMP returns, which did not show large differences between FMPs generated over different universes as shown by chart 490 of FIG. 11.

In chart 508, curve 510 is the same active return shown by curve 502 in chart 500. In this case, however, PA was performed using FMPs constructed over the Russell 1000 universe, the same universe used to construct the mean-variance, unconstrained, medium-term momentum portfolios. In this case, the factor contribution, 512, is identical to the active return 510, and the specific contribution, 514, is identically zero. A PA quality metric would indicate high quality.

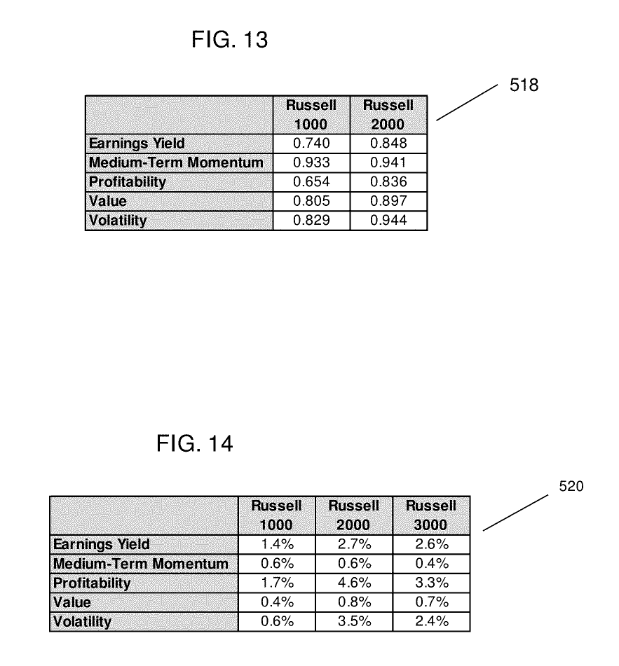

Table 518 in FIG. 13 gives the correlation of the FMP returns for five different factors constructed using either the Russell 1000 equity index universe or the Russell 2000 equity index universe. In each case, the correlation is computed to the FMP returns of the corresponding factor using the Russell 3000 universe. The five factors detailed are earnings yield, medium-term momentum, profitability, value, and volatility. The first four FMP returns have positive unit exposure to the factor, while volatility has a negative unit exposure. It has already been seen that the cumulative returns of these FMPs can differ substantially; the differences in correlation are consistent with these results. The smallest difference in correlation between the Russell 1000 and the Russell 2000 universes is medium-term momentum. In the previously shown results, the PA analysis for medium-term momentum was similar using both the Russell 1000 and Russell 3000 FMPs. The largest difference in correlation is profitability, which, as seen previously, had the large difference in PA analysis between the Russell 1000 and Russell 3000 FMPs.

In the analysis shown in FIG. 13, the correlation given is not a PA quality metric. Instead, it shows the similarity between the Russell 1000 and Russell 2000 FMPs when compared against FMPs constructed over the Russell 3000. In this case, high correlation indicates similar RMP returns, which in turn indicates that the FMP universe is not as large a driver of differences in the PA.

Table 520 in FIG. 14 gives the annualized returns of the FMPs for five different factors constructed using either the Russell 1000 equity index universe, the Russell 2000 equity index universe, or the Russell 3000 equity index universe. The five factors detailed are earnings yield, medium-term momentum, profitability, value, and volatility. The first four FMP returns have positive unit exposure to the factor, while volatility has a negative unit exposure. As already seen with the PAs previously performed, there are meaningful differences in these returns. The largest differences occur with profitability, which had the large disagreements in PA, and also volatility. The smallest differences occur for medium-term momentum, which has the least disagreement with PA, and value.

It is concluded from this data, as well as the data in table 518, that differences in FMP annualized returns and correlations between universes correspond to important differences in PA analyses.

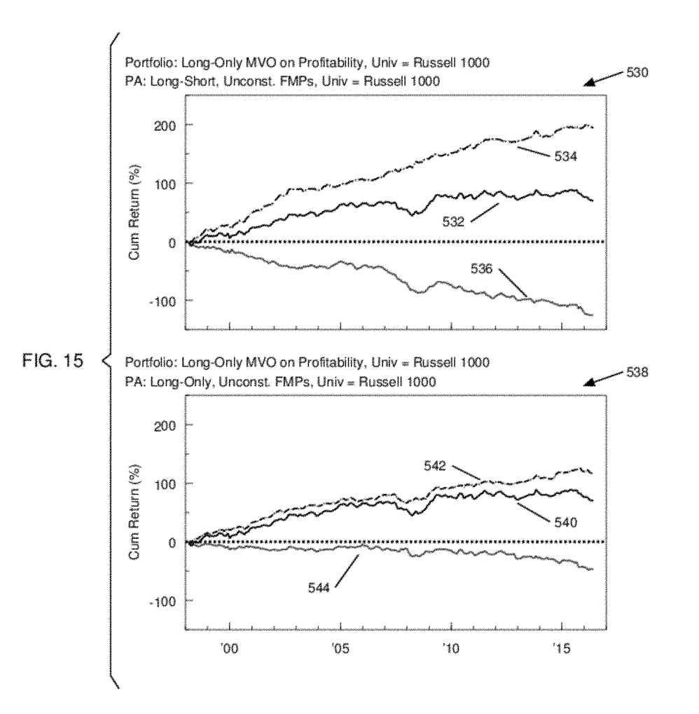

FIG. 15 shows two different PAs for the long-only, mean variance portfolio tilted on profitability. In chart 530, the PA is performed using the standard, long-short FMPs for profitability. The factor 534 and specific 536 contributions are both large but of opposite signs. When taken together, they add up to the active return 532. This PA has a poor PA quality metric.

In chart 538, the same portfolio is analyzed, but now the FMPs used for PA are derived with a long-only constraint. In this case, when the active return 540 is decomposed into factor and specific contributions, only the factor contribution 542 is significant. The specific contribution 544 is small throughout the time period analyzed. This PA would have a good PA quality metric. Hence, having the FMPs used for PA use similar constraints satisfied by the investment portfolio improves the interpretability of the PA results illustrated here.

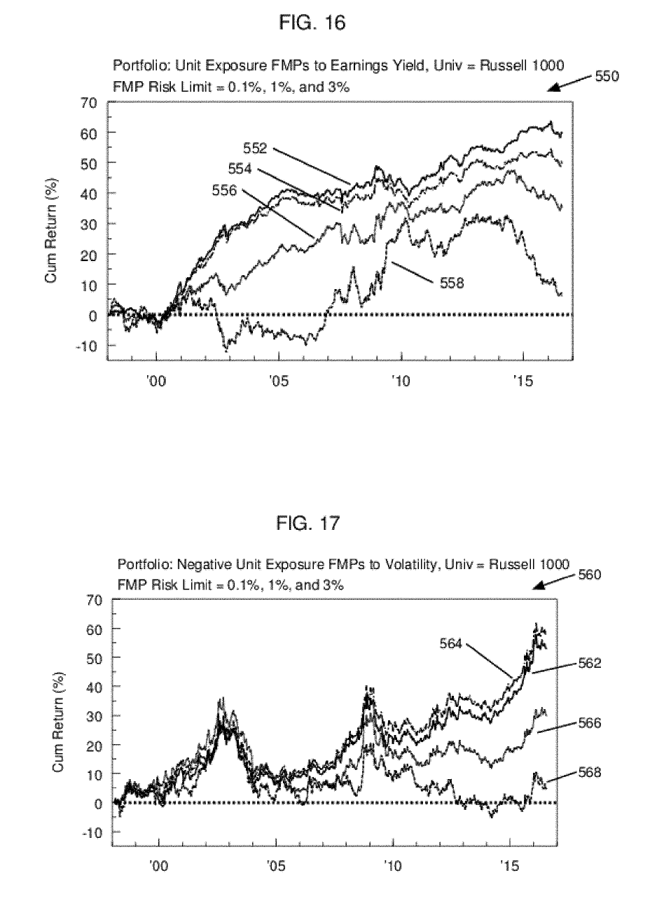

Chart 550 in FIG. 16 shows the returns of several different FMPs with unit exposure to earnings yield constructed over the assets in the Russell 1000. The traditional, long-short earnings yield FMP has the cumulative return 552. For the other PAs, FMPs are constructed that are long-only, with a unit exposure to earnings yield and with different maximum risk limits as described in equations (20)-(23). For curve 554, the risk limit is 0.1% annual volatility. With this low risk limit, the factor contribution is very close to the traditional, long-short FMP cumulative return. For curve 556, the risk limit is 1% annual volatility. The cumulative return for this FMP differs substantially from the traditional FMP cumulative return. For curve 558, the risk limit is 3% annual volatility. For this FMP, the cumulative return is not similar to the traditional FMP cumulative return. These results indicate that setting different risk limits for the long only FMPs can substantially change the cumulative return of the FMP.

Chart 560 in FIG. 17 shows the returns of several different FMPs with unit negative exposure to volatility constructed over the assets in the Russell 1000. The traditional, long-short, low volatility FMP has the cumulative return 562. For the other PAs, FMPs are long-only with a negative unit exposure to volatility, and have different maximum risk limits. For curve 564, the risk limit is 0.1% annual volatility. With this low risk limit, the factor contribution is somewhat similar to the traditional FMP cumulative return. For curve 566, the risk limit is 1% annual volatility. The cumulative return for this FMP differs substantially from the traditional FMP cumulative return. For curve 568, the risk limit is 3% annual volatility. For this FMP, the cumulative return is not similar to the traditional FMP cumulative return.

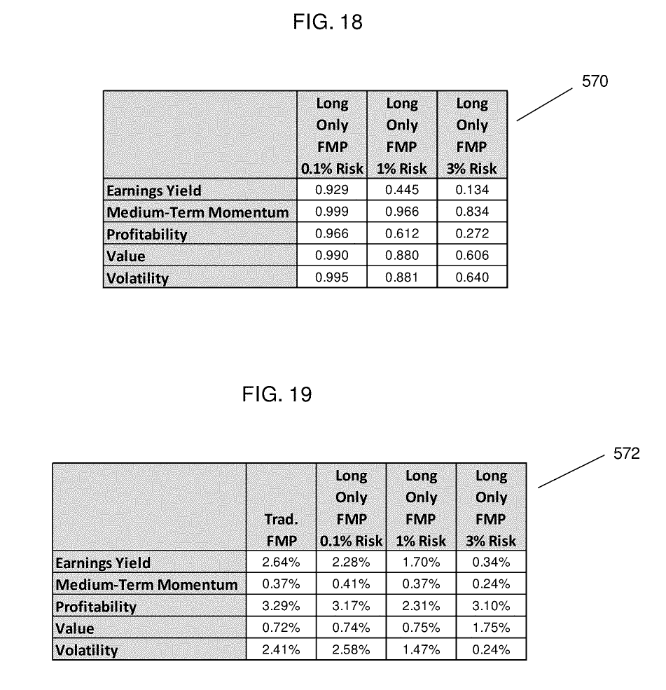

Table 570 in FIG. 18 shows the time series correlation of the long-only, FMPs with unit exposure to the factor (negative unit exposure for volatility) with different levels of risk versus the time series of returns for the corresponding traditional, long-short FMP. As would be expected from the previous results, the correlation is quite high (>0.99) for a risk limit of 0.1%. As the risk limit increases to 1% or 3%, the correlation decreases, in some cases substantially. This reconfirms the observation that the higher the risk limit, the more dissimilar the FMP returns become. Note again that the correlations in FIG. 18 are not PA quality metrics as they are the correlations of different FMPs over time, not the correlation with a specific return time series.

Table 572 in FIG. 19 shows the annualized returns of the traditional FMPs and the long only, unit exposure (minus unit exposure for volatility) FMPs with different levels of allowable risk. Unlike the previous results, the annualized FMP returns do not necessarily differ as the risk limit increases. For earnings yield and volatility, it decreases. For medium-term momentum and profitability, it remains roughly the same. For value, it increases. These results once again highlight the importance of the choice of FMPs when computing a PA.

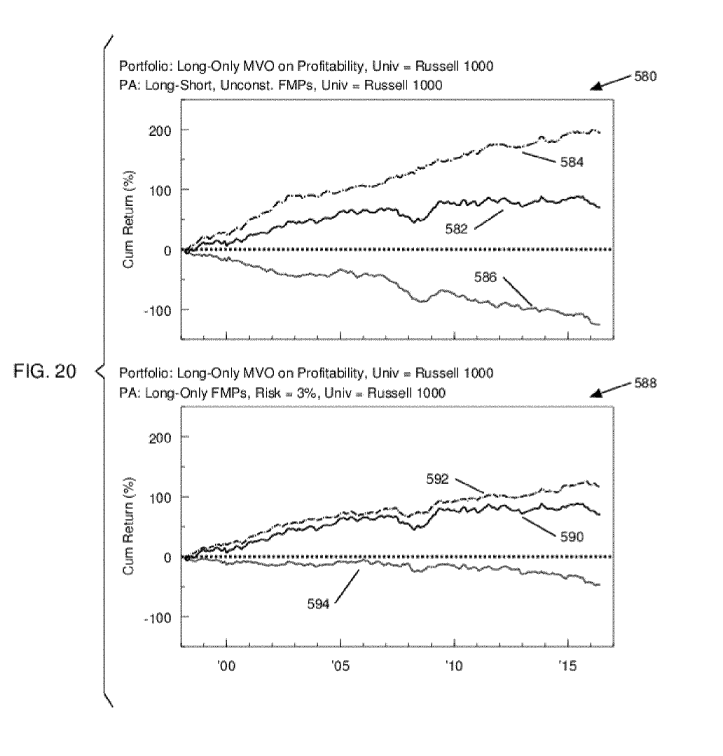

FIG. 20 shows two different PAs for the long-only, mean variance portfolio tilted on profitability. In chart 580, the PA is performed using the standard, long-short FMPs for profitability. As seen before, the factor 584 and specific 586 contributions are both large but of opposite signs. When taken together, they add up to the active return 582. This PA would have a poor quality metric.

In chart 588, the same portfolio is analyzed, but now the FMPs used for PA are derived with a long-only constraint and a fixed risk limit of 3% annual volatility. In this case, when the active return 590 is decomposed into factor and specific contributions, only the factor contribution 592 is significant. The specific contribution 594 is small throughout the time period analyzed. FIG. 20 illustrates how advantageous it can be to use FMPs that have similar characteristics as the underlying portfolio, for example, long-only. This PA would have a strong quality metric.

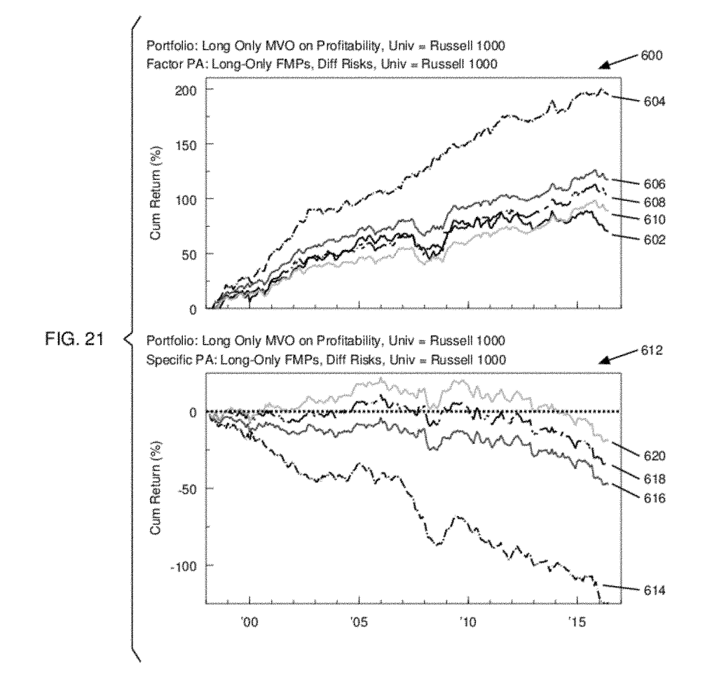

FIG. 21 shows a series of PA curves corresponding to PAs for a long-only, mean variance portfolio tilted on profitability. The factor contributions and active returns are shown in chart 600. Curve 602 is the active return of the portfolio. Curve 604 is the factor contribution using a standard long short FMP. This curve 604 deviates the most from the active return. Curve 606 is the factor contribution of a long only FMP with a risk limit of 3%. This curve 606 is much closer to the active return than curve 604. Curve 608 is the factor contribution of a long only FMP with a risk limit of 4% annual volatility. Curve 610 is the factor contribution of a long only FMP with a risk limit of 5% annual volatility. The 4% risk curve 610 and the 5% risk curve 610 are the closest to the active return.

In chart 612, the corresponding specific returns are shown. Curve 614 is for the traditional FMP; curve 616 is 3% risk; curve 618 is 4% risk; and curve 620 is 5% risk. The 4% risk curve 618 and the 5% risk curve 620 both have very small specific returns throughout the time period. FIG. 21 illustrates how advantageous it can be to use FMPs that have similar characteristics as the underlying portfolio (e.g., long-only). These advantages will translate into better PA quality metrics.

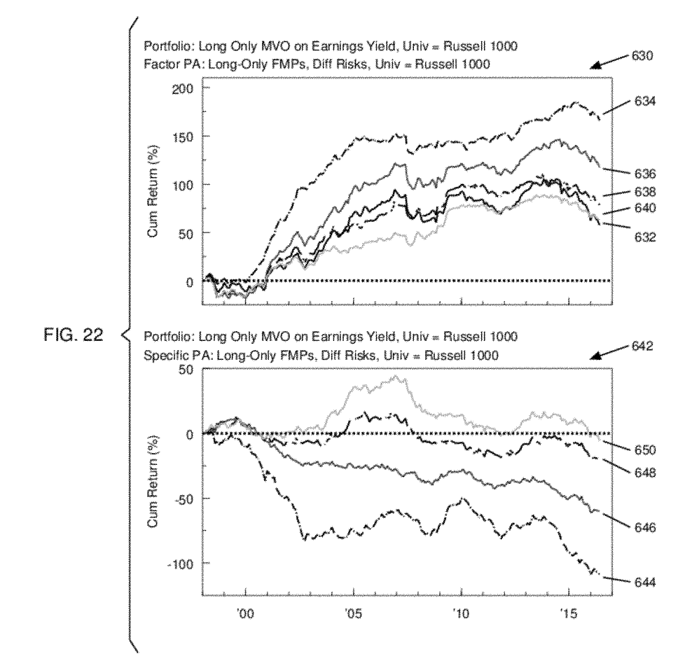

FIG. 22 shows a series of PA curves corresponding to PAs for a long-only, mean variance portfolio tilted on earnings yield. The factor contributions and active returns are shown in chart 630. Curve 632 is the active return of the portfolio. Curve 634 is the factor contribution using a standard long short FMP. This curve 634 deviates the most from the active return. Curve 636 is the factor contribution of a long only FMP with a risk limit of 1%. This curve 636 is much closer to the active return than curve 634. Curve 638 is the factor contribution of a long only FMP with a risk limit of 2% annual volatility. Curve 640 is the factor contribution of a long only FMP with a risk limit of 3% annual volatility. The 2% risk curve 640 and 3% risk curve 640 are the closest to the active return.

In chart 642, the corresponding specific returns are shown. Curve 644 is for the traditional FMP; curve 646 is 1% risk; curve 648 is 2% risk; and curve 650 is 3% risk. The 2% risk curve 648 and the 3% risk curve 650 both have small specific returns throughout the time period. FIG. 22 illustrates again how advantageous it can be to use FMPs that have similar characteristics as the underlying portfolio, for example long-only.

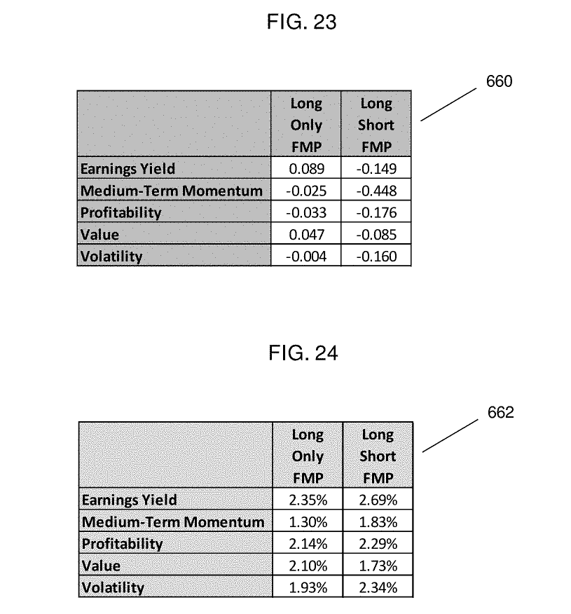

FIG. 23 shows a table 660 of the time series correlation of the factor contributions and the specific contributions both for a traditional long-short FMP and a long-only FMP for five factors with unit exposure: earnings yield, medium-term momentum, profitability, value, and (negative unit exposure) volatility. Ideally, these correlations should be close to zero, as the specific contributions are intended to be uncorrelated with the factor contributions. However, the table 660 indicates that in the traditional long-short FMPs, factor and specific contributions are strongly, negatively correlated. This table corroborates the results seen previously in which the factor and specific contributions are both large and of opposite sign. However, for the long-only FMPs, the correlations are substantially reduced, resulting in a more intuitive PA. This illustrates the use of the correlation between factor and specific contributions as a metric for evaluating PAs. For this metric, smaller magnitude correlations indicate better PAs.

FIG. 24 shows a table 662 of the realized, specific volatility of the time series of specific contributions both for a traditional long-short FMP and a long-only FMP for five factors with unit exposure: earnings yield, medium-term momentum, profitability, value, and (negative unit exposure) volatility. The overall magnitude of the specific volatility is about the same for all factors ranging from 1.30% annual volatility to 2.69% annual volatility. In general, the long-only specific FMP volatility is slightly smaller than the long-short FMP volatility. This table 662 indicates that the long-only FMPs have a better fit to the underlying portfolio and again illustrates another metric that may be used to evaluate the quality of the PA results; in this case the specific volatility. For this metric, smaller magnitude specific volatilities indicate better PAs.

The approach outlined above works well in most cases, but it does have some nuances in terms of how it works in practice. As shown above, when PA is performed on the returns of an unconstrained, long-short mean variance portfolio, portfolios can be found that explain the portfolio performance perfectly, for example, they have no specific contribution. However, when a simple long-only constraint is added to the construction of the portfolio, portfolios are no longer found that perfectly explain the portfolio performance. Portfolios can be found with relatively small specific contributions, indicating a higher quality PA, but in general it is not possible to make the specific contribution identically zero.

To understand why this happens, it is helpful to consider in more detail why we are able to perfectly explain an optimal mean variance portfolio as long as no constraints such as long-only are present.

As equation (16) showed, even a simple mean variance bet on a single signal results in exposure to many factors. Specifically, we see that the optimal portfolio can be written as

h=ΣθⱼΔ⁻¹Xⱼ (24)

Each term Δ⁻¹Xⱼ can be thought of as the optimal solution to

max Xⱼ^{T}h−h^{T}Δ⁻¹h/2 (25)

and that a weighted sum of the optimal solutions to each of these optimization problems is equal to the optimal solution of

max(ΣθⱼXⱼ)^{T}h−h^{T}Δ⁻¹h/2 (26)

In other words, in this unconstrained scenario, mixing portfolios coming from equation (25) is equivalent to mixing signals first and constructing a portfolio from the mixed signal. It is this principle that allows an explanation of optimal unconstrained mean variance portfolios perfectly through portfolios.

However, once long-only constraints are added, this result no longer holds. For example, it can no longer be guaranteed that the optimal solution to

max(ΣθⱼXⱼ)^{T}h−h^{T}Δ⁻¹h/2 (27)

h≥−b (28)

has the same properties, e.g., is identical to the weighted sum of optimal solutions for each factor. Understanding the difference between long-only constrained portfolios obtained by mixing individual portfolios versus those obtained by first mixing the signals can be instructive in understanding why it is not possible to rely on perfect attributions of long-only constrained portfolios.

Specifically, it is desired to understand the difference between constructing portfolios in two different ways:
1. First portfolios are constructed that bet on individual signals, each satisfying a long-only constraint. These portfolios are then linearly combined to obtain a final portfolio.
2. Next, signals are linearly combined, and then a long-only constrained optimal portfolio is constructed that bets on this combined signal.
   The principal cause of the difference between these two approaches is that the long only constraint limits the magnitude of the possible underweight. For example, suppose for a particular asset the first signal is very high and the second signal is very low. The average signal will be zero, so the mixing portfolio allocation which combines those signals to that asset will be quite small. However, if two long only portfolios are first constructed, one to each signal, then the FMP to the high first score will have a large asset weight, whereas the FMP to the second, low score cannot be equally large and negative; it can only be underweighted by an amount of the asset equaling the holding of that asset in the benchmark. As a result, when the two FMPs are averaged, the high, large overweight will dominate. As a result, mixing portfolio does not yield the same portfolio as mixing signals in this context.

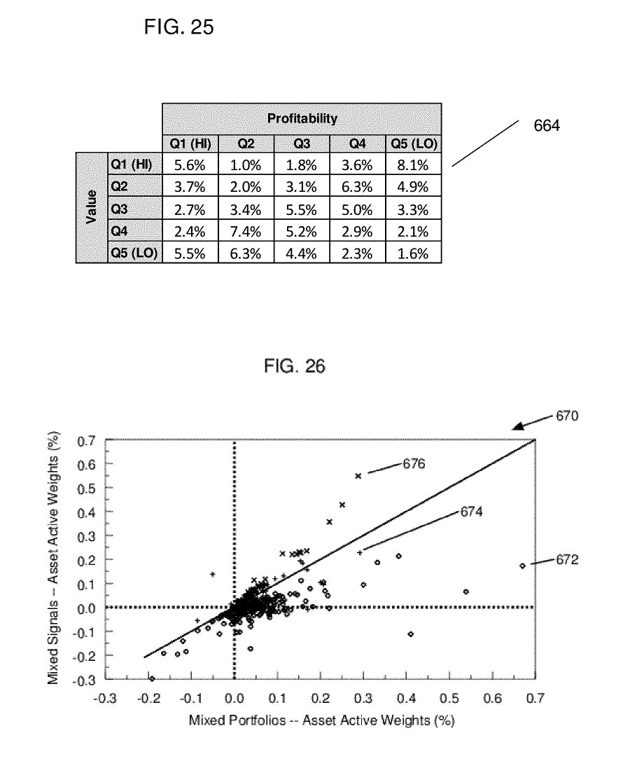

This result is further illustrated as follows. Consider constructing FMPs for the Russell 3000 universe on the two factors profitability and value. FIG. 25 shows a table 664 of the distribution of assets broken down into quintiles of each factor score. The point of table 664 is to show that there are quite a few assets that have a high score in one factor and a low score in the other. In fact, the largest bucket in table 664 is 8.1% for Q5 (LO) profitability and Q1 (HI) value.

An illustration comparing mixing portfolios and mixing signals is shown by chart 670 in FIG. 26. For these results, the Russell 3000 universe is used, and two signals, profitability and value, the same signals and universe illustrated in table 664. Here, two FMPs are constructed, one by mixing portfolios, the other by mixing signals. Then, the active weights are plotted of three different quintiles of assets: a quintile grouping with high profitability and low value, shown by the exemplary diamond 672; a quintile grouping with high value and low profitability shown by the exemplary plus sign 674; and a quintile grouping shown with high profitability and high value shown by the exemplary crosses 676. The chart 670 plots the active weights of the mixed portfolio FMP on the horizontal axis and the active weights of the mixed signal FMP on the vertical axis. The solid line is the 45-degree line; any points below this line correspond to weights that are higher when mixing portfolios as opposed to mixing signals. In the case of high value and low profitability, indicated by the diamonds, the active weights are mostly below the solid line, indicating that the mixed portfolio weighted to be larger than the signal weights. Similarly, in the case of high value and low profitability, indicated by the pluses, the active weight of the mixed portfolio is larger than the active weight when mixing signals. Finally, for the high profitability and high value case indicated by the crosses, the active weights are largely above the solid line, showing higher weights when mixing signals as opposed to mixing portfolios. In short, for the opposite quintiles, the points largely lie below the 45-degree line, which indicates that the mixed portfolio positions are larger than the mixed signal portfolio positions regardless of whether the grouping is Q1Q5 or Q5Q1. On the other hand, for those assets with high value and high profitability, the active weight resulting from mixing signals tends to be higher, because more of the portfolio's leverage is concentrated on generating overweights for those assets.

The purpose of these comparisons is to illustrate why PA results for long-only constrained mean variance portfolios can usually not be perfectly explained by long-only constrained FMPs, since combining these FMPs (portfolios that bet on individual signals) is not equivalent to mixing the signals and constructing the portfolio based on the mixed signal.

The point illustrated by this data is that there can be substantial differences in the assets weights for long-only FMPs when more than one signal is combined. These differences extend to different approaches such as mixing portfolios and mixing signals.

Another important practical nuance relates to the frequency at which factor returns and FMPs are rebalanced. For many commercial factor risk model providers, the factor returns and risk models are updated on a daily basis. However, in practice very few portfolios are rebalanced or updated at that frequency. Often portfolios may be rebalanced once a month or once a quarter in an effort to minimize the trading and transaction costs for the portfolio. As a result, these portfolios do not react to daily changes in factor scores or exposures as the commercially available, daily factor returns do.

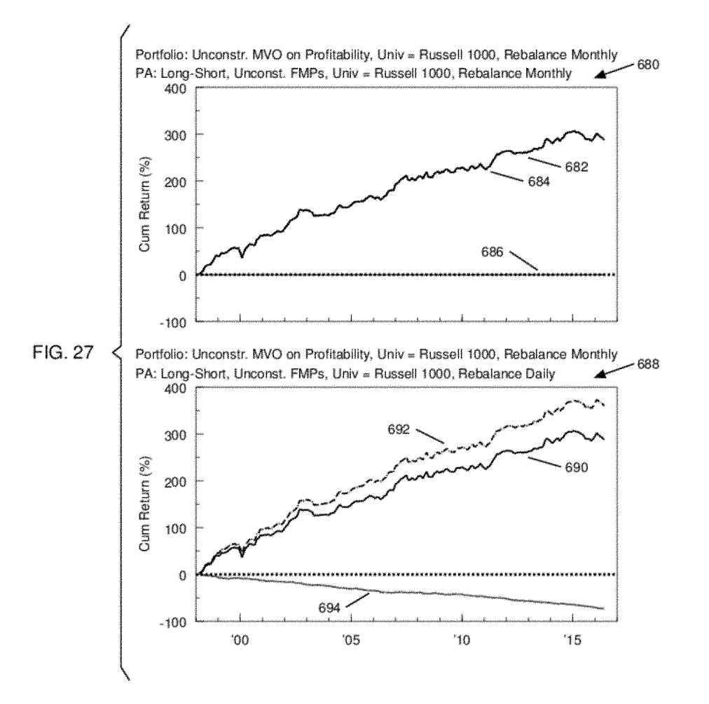

The flexibility of the FMP approach of the present invention allows PA to be performed with a rebalance frequency that matches the portfolio rebalance schedule. This approach improves the PA by minimizing the misalignment between the FMPs and the portfolio. FIG. 27 illustrates the impact of rebalance frequency for a long-short, unconstrained, minimum variance portfolio tilting on profitability constructed using the Russell 1000 assets. Chart 680 shows the PA performed with long-short FMPs in which the FMPs are rebalanced on a monthly basis, which is the same rebalance frequency as the portfolio. In this case, the active return 682 and the factor contribution 684 are identical and undistinguishable. The specific contribution 686 is identically zero.

In chart 688, PA is performed using FMPs that are rebalanced daily. In this case, the active return 690 is the same, but now the factor return 692 is similar to but not identical to the active return. The specific return 694 is now small but negative. The PA in chart 688 is still intuitive, but not as ideal as the PA shown in 680.

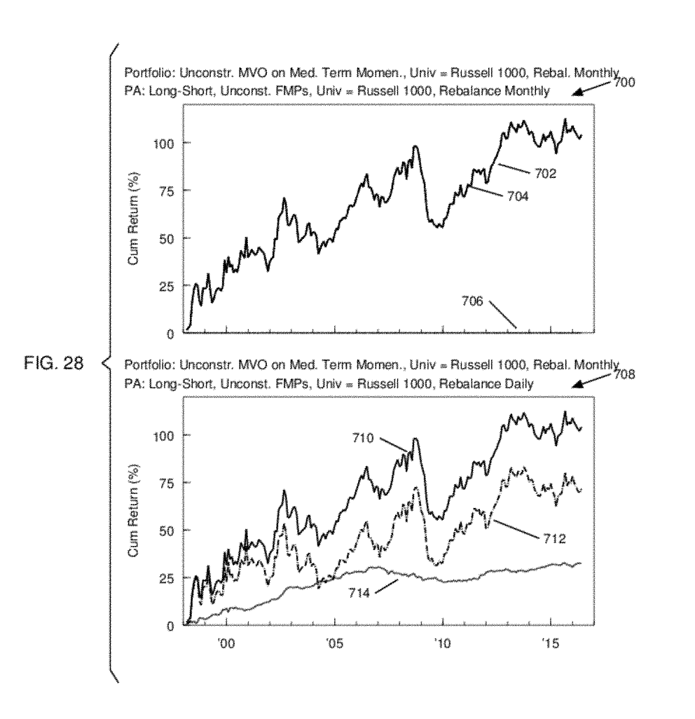

FIG. 28 illustrates the impact of rebalance frequency for a long-short, unconstrained, minimum variance portfolio tilting on medium-term momentum constructed using the Russell 1000 assets. Chart 700 shows the PA performed with long-short FMPs in which the FMPs are rebalanced on a monthly basis, which is the same rebalance frequency as the portfolio. In this case, the active return 702 and the factor contribution 704 are identical and undistinguishable. The specific contribution 706 is identically zero.

In chart 708, PA is performed using FMPs that are rebalanced daily. In this case, the active return 710 is the same, but now the factor return 712 is similar to but not identical to the active return. The specific return 714 is now small but positive. The PA in 708 is still intuitive, but not as ideal as the PA shown in 700.

Another aspect of the present invention is the ability to use the FMP characteristics in a high quality FMP-based PA as descriptors of the historical portfolios or the portfolio manager in charge of those portfolios. In a large investment bank with dozens or hundreds of portfolio managers and PAs, a database that identified those FMP characteristics that were most associated both with high quality PA and with out-performance, that is portfolio returns that were positive or greater than a benchmark return, could be used to screen portfolio managers and guide the allocation of investment funds. The database would be advantageous for identifying those portfolio managers who consistently out-perform the market and choose advantageous factors.

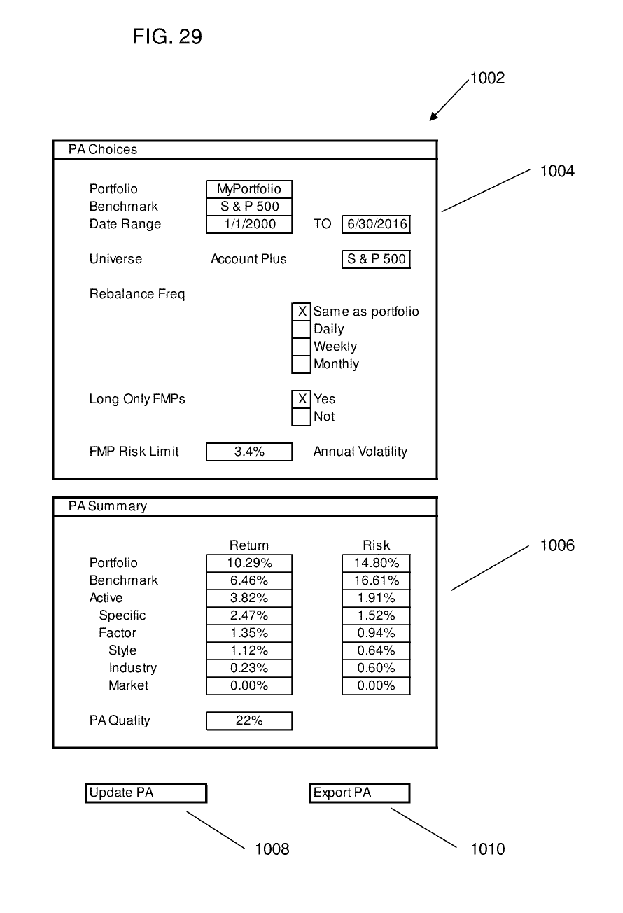

FIG. 29 shows an example sample graphical user interface 1002 exemplifying how the present invention may be advantageously employed. In a top section 1004, the user may enter parameters to alter the FMP-based PA that will be performed. The parameters include the name of the portfolio to be analyzed, the appropriate benchmark, if any, and the date range over which the PA will be performed. The window also has a selection of the appropriate universe over which the FMPs are to be derived, the rebalance frequency for the FMPs, a selection of whether or not the FMPs are long only, and a risk limit, if any, to impose on the FMPs.

In a second window 1006, a summary of the most recent PA results is presented. This summary includes a decomposition of the returns and risk across the factors and specific components. In addition, a metric defining the quality of the PA may also be presented. The summary may also include graphical representations of the cumulative factor and specific returns.

There are also two user indications in the graphical user interface. There is an “Update PA” indicator or button 1008 that may be pressed by the user to start the new PA analysis. There is also an “Export PA” indicator or button 1010 that will take the most recent PA results and export them to a database or file or trading system. The exported PA results could also be exported to a portfolio construction and management system that would attempt to capitalize on the PA results by altering investment portfolios to increase those factor exposures that have worked historically and reduce those factor exposures that have not worked historically.

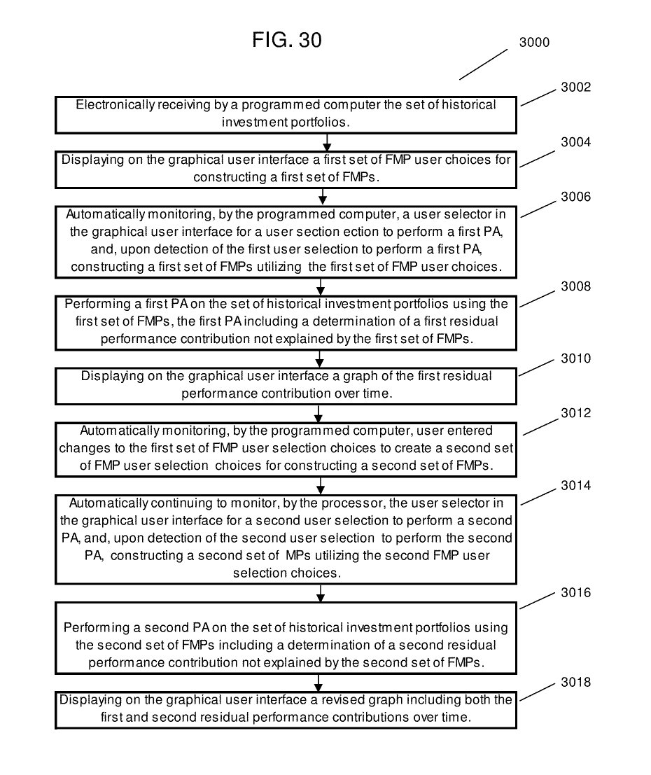

FIG. 30 shows illustrative aspects of a computer implemented method 3000 for interactively displaying factor-mimicking portfolio (FMP)-based performance attribution (PA) for a set of historical investment portfolios within a graphical user interface which displays graphs of residual performance contributions not explained by FMPs in accordance with the present invention.

In step 3002, the set of historical investment portfolios is electronically received by a programmed computer. For example, where a portfolio manager wishes to compare the results of a group of potential fund investors, historical investment portfolios may be obtained from that group of potential fund investors and stored in digital storage, such as database 272 of FIG. 3B from which they may be retrieved and electronically received by computer 271.

In step 3004, a first set of user choices for constricting a set of FMPs are displayed on the graphical user interface. For example, user choices may be displayed on display 22 of system 100 or touchscreen 275 of computer 271 of the user system 270. One exemplary set of user choices comprises long only, maximum risk value for each FMP, a maximum turnover value for each FMP, a rebalance frequency, and an FMP universe of potential investments. Such choices may be selected by clicking on an item listed in a selectable menu, typing a selection into a selection box, touching a button or other user selector on a touchscreen or the like.

In step 3006, a user selector in the graphical user interface is automatically monitored by the programmed computer and upon determining a user selection to perform PA, constructing a first set of FMPs utilizing the first set of user choices. By way of example, a user selector is displayed on the graphical user interface or the display 22 or touchscreen of 275 of system 100 or user system 270, respectively. The user selector may suitably comprise a selector button labeled “Perform PA” or the like.

In step 3008, a first PA is performed on the first set of historical investment portfolios using the first set of FMPs, the first PA including a determination of a first residual performance contribution not explained by the first set of FMPs.

In step 3010, a graph of the first residual performance contribution over time is displayed on the graphical user interface. For example, a graph like any of graphs 336, 344, 366, 374, 396, 404, 416, 424, 476, 484, 506, 514, 536, 544, 586, 594, 614, 616, 618, 620, 644, 646, 648, 650, 686, 694, 706, and 714 shown in FIGS. 4, 5, 6, 7, 10, 12, 15, 20, 21, 22, 27, and 28, respectively is displayed on the display 22 or the touchscreen 275.

In step 3012, user entered changes to the first set of user choices are automatically monitored by the programmed computer to create a second set of user choices for constructing a second set of FMPs. As one example, where a user first selected long only, that choice might be replaced with a frequency of rebalancing of once a month.

In step 3014, automatically continuing to monitor by the programmed computer the user selection in the graphical user interface for a second user selection to perform a second PA, and upon detection of this second user selection to perform the second PA, constructing the second set of FMPs utilizing the of user selection.

In step 3016, the second PA is performed on this set of historical investment portfolios using the second set of FMPs including a determination of a second residual performance contribution not explained by the second set of FMPs.

In step 3018, a revised graph including both the first and the second residual performance contributions over time is displayed on the graphical user interface.

Although the present invention has been described in terms of FMPs derived using an optimization framework, the present invention is not limited to optimized FMPs. The customized FMP-based PA framework is more broadly applicable. It may be that other kinds of customized FMPs perform differently and advantageously than the particular cases described here. For example, turnover-constrained FMPs, FMPs with a limited number of names held, tax-aware FMPs, rules-based FMPs such as top minus bottom quintiles or Fama-French portfolios, and the like may be utilized within the framework of the present invention. In addition, the FMPs may be constructed using multiple descriptors or variables for each factor.

While the present invention has been disclosed in the context of various aspects of presently preferred embodiments, it will be recognized that the invention may be suitably applied to other environments consistent with the claims which follow.

We claim:

1. A computer-implemented method for interactively displaying factor-mimicking portfolio (FMP)-based performance attribution (PA) for a set of historical investment portfolios within a graphical user interface which displays graphs of residual performance contributions not explained by FMPs, the method comprising:
electronically receiving by a programmed computer the set of historical investment portfolios;
displaying on the graphical user interface a first set of FMP user choices for constructing a first set of FMPs;
automatically monitoring, by the programmed computer, a user selector in the graphical user interface for a first user selection to perform a first PA, and, upon detection of the first user selection to perform the first PA, constructing a first set of FMPs satisfying the first set of FMP user choices;
performing the first PA on the set of historical investment portfolios using the first set of FMPs, the first PA including a determination of a first residual performance contribution representing a part of a historical portfolio return not explained by the first set of FMPs;
automatically monitoring, by the programmed computer, user entered changes to the first set of FMP user choices to create a second set of FMP user choices for constructing a second set of FMPs;
automatically continuing to monitor, by the processor, the user selector in the graphical user interface for the second user selection to perform a second PA, and, upon detection of the second user selection to perform the second PA, constructing a second set of FMPs satisfying the second FMP user choices;
performing the second PA on the set of historical investment portfolios using the second set of FMPs including a determination of a second residual performance contribution representing a part of a historical portfolio return not explained by the second set of FMPs; and
displaying on the graphical user interface a graph including the first and second residual performance contributions over time.

2. The method of claim 1 wherein upon receiving a selection by a user to Export PAs, the first or second PAs is exported to a database or file.

3. The method of claim 1 wherein the set of FMP user choices includes at least one of a choice of long only versus both long and short positions, a maximum FMP risk limit, a maximum FMP turnover limit, a rebalance frequency, or an FMP universe of potential investments.

4. The method of claim 3 wherein a PA metric of residual performance is displayed on the graphical user interface for each residual performance contribution graph.

5. The method of claim 4 where the PA determines factor contributions for each FMP and where the PA metric is either a correlation of factor and specific contributions or a volatility of the residual contributions.

6. The method of claim 3 further comprising:
associating at least one FMP user choice with a portfolio manager corresponding to a particular historical investment portfolio.

7. The method of claim 6 further comprising:
associating multiple FMP user choices with multiple portfolio managers corresponding to particular historical investment portfolios.

8. The method of claim 7 further comprising:
ranking the multiple portfolio managers based upon both return of historical investment portfolios and their FMP user choices.

9. A computer-implemented method for associating a set of preferred characteristics for factor-mimicking portfolios (FMPs) to a set of historical investment portfolios, the method comprising:
electronically receiving by a programmed computer the set of historical investment portfolios;
electronically receiving by the programmed computer a plurality of FMP scenarios, each scenario comprising a list of characteristics that define a set of FMPs;
determining, by a processor, the set of FMPs for each FMP scenario where each FMP satisfies the characteristics of the scenario;
determining, by a processor, a performance attribution (PA) of the set of historical investment portfolios for each FMP scenario using the set of FMPs defined by the FMP scenario where each PA determines factor contributions for each FMP and a residual contribution;
computing for each PA a measure of the quality of the PA;
determining, by the processor, the FMP scenario and PA whose quality metric is preferred among all FMP scenarios and PAs; and
outputting the preferred FMP scenario and PA.

10. The method of claim 9 wherein the characteristics for each FMP scenario includes at least one of the characteristics long only versus both long and short positions, a maximum risk value for each FMP, a maximum turnover value for each FMP, a rebalance frequency, or an FMP universe of potential investments.

11. The method of claim 10 wherein a database stores each preferred FMP scenario and the associated manager of the historical portfolios.

12. The method of claim 10 where the measure of PA quality is either the correlation of factor and residual contributions or a volatility of residual contributions.

13. The method of claim 12 wherein a most recent portfolio from the set of historical investment portfolios is altered to reduce its exposure to FMPs with negative factor contributions.

14. A computer-implemented method for identifying factors likely to be poorly attributed in a traditional factor based performance attribution, the method comprising:
electronically receiving by a programmed computer a set of historical investment portfolios;
electronically receiving by the programmed computer a factor risk model defining factor exposures, factor returns, and specific returns;
determining, by a processor, a performance contribution for each factor in the factor risk model and a residual contribution by computing a traditional, factor-based performance attribution (TFPA) for the set of historical investment portfolios using the factors, factor exposures, factor returns, and specific returns of the factor risk model;
electronically receiving by the programmed computer a set of characteristics defining a factor-mimicking portfolio (FMP) for each factor in the factor risk model;
determining, by the processor, a set of FMPs, each FMP satisfying the characteristics defining that factor's FMP;
determining, by the processor, a performance contribution for each factor in the factor risk model and a residual contribution by computing an FMP-based performance attribution (FMPPA) for the set of historical investment portfolios using the set of FMPs;
electronically receiving by the programmed computer a difference threshold; and
outputting, by the processor, the factors in the factor risk model for which a difference between the TFPA performance contribution and the FMPPA performance contribution for that factor is more than the difference threshold.

15. The method of claim 14 wherein the characteristics for each FMP scenario include at least one of the characteristics long only versus both long and short positions, a maximum risk value for each FMP, a maximum turnover value for each FMP, a rebalance frequency, or an FMP universe of potential investments.
